(19) United States
(12) Patent Application Publication
(10) Pub. No.: US 2023/0011744 A1
(43) Pub. Date: Jan. 12, 2023

(54) DUAL COLLAR TANK CAP LOCKING DEVICE

(71) Applicant: Peter Joseph Mollick, Phoenix, AZ (US)

(72) Inventor: Peter Joseph Mollick, Phoenix, AZ (US)

(21) Appl. No.: 17/392,173

(22) Filed: Aug. 2, 2021

Related U.S. Application Data
(60) Provisional application No. 63/220,675, filed on Jul. 12, 2021.

(51) Int. Cl. B60K 15/04; B65D 55/14; F17C 13/06

(52) U.S. Cl. CPC B60K 15/0409; B65D 55/14; F17C 13/06; F17C 2205/0173

(57) ABSTRACT

The disclosed invention relates to maintaining a closed and secured position of a tank fill port cap on a tank such as a fuel tank. The invention comprises a dual collar structure providing a means for the attachment of a lockable blocking device to prevent a tank fill port cap from being removed from a tank fill port nipple. The lockable blocking device is removably and securely installed on a first collar and wherein the first collar is removably and securely installed on a tank fill port nipple such as on a large commercial truck fuel tank. The first collar and the blocking device discourages or prevents the theft or vandalism of the contents of the tank. The first collar attaches to the tank fill port nipple with setscrews in a continuous one piece collar or a clamp screw in a clamping split collar configuration. A second collar is fitted over the first collar covering the first collar attachment means preventing tampering or removal of the first collar. The second collar is secured in position by the blocking device being attached to the first collar requiring the blocking device to be removed from the first collar in order to remove the second collar from the first collar, therefore, maintaining a secure and removable dual collar device locking device to secure and protect the contents of a tank by preventing the tank cap from being removed. In addition, the lockable blocking device is required to reside in a position that does not interfere with a tank pressure relief device that may be centered in the fill port cap.

### CROSS-REFERENCE TO RELATED APPLICATIONS

This application claims the benefit of U.S. Provisional Patent Application No. 63/220,675 titled “LOCKABLE TANK FILL-PORT CAP SECURING DEVICE” filed Jul. 12, 2021, the contents of which are incorporated herein by reference in their entirety.

### BACKGROUND OF THE INVENTION

Locking tank caps are used for many applications such as tanks of various uses like fuel tanks, water tanks, chemical tanks, food tanks, and many other types of tanks used in industry. The locking caps are used to secure the contents of the tank from theft, vandalism, spillage, or other types of tampering. Generally the tank cap is attached to a fill port nipple that allows the cap to either thread in place, snap in place or simply secure in place under tabs on the fill port nipple. One example of a locking fill-port tank cap for a vehicle fuel tank is commonly called a locking fuel cap. Large transportation vehicles such as semi-trucks carry a large amount of fuel for transportation of products on long distances throughout the country in use and a locking fuel tank cap is an added advantage used to prevent theft of the fuel.

Additional examples of locking tank caps for tank fill-ports are locking caps on oil tanks and food grade grease tanks to prevent contamination of the product stored in the tanks, although the most common use of a tank fill-port locking cap is on a vehicle fuel tank. Various locking tank caps are available for vehicle fuel tanks wherein the cap encloses the locking device that is actually a slip device that causes the cap handle to freely spin without engaging the cap insertion base that is held in the tank fill-port with threads, or the tank cap may have a locking shelf to maintain the closed and secured position of the tank cap. This type of locking fuel cap is mostly found on passenger cars and light trucks.

Another application of locking tank caps can be found on the previous mentioned large commercial diesel powered transportation trucks commonly called semi-trucks. Semi-trucks generally employ a large diesel fuel tank on the side of the truck with a large gallon capacity of at least 60 gallons or more. The tank fill-port is usually a metal tube nipple on the top of the tank with internal female threads allowing a metal cap with male threads to thread into the fill-port nipple. The tank cap normally contains a pressure vent on the cap to release undesirable pressure in the fuel tank when needed. Fuel theft is a common problem in the trucking industry creating a market for diesel fuel tank locking caps. Another design of the tank fill-port nipple and the tank cap is a fill-port nipple with external male threads allowing a metal tank cap with female threads to screw onto and over the fill-port nipple.

One current design of a locking tank cap on a diesel fuel tank is wherein the tank fill-port comprises a flange attached to the fill-port nipple with an attachment method such as welding the flange to the fill-port nipple. The flange contains a hole or holes along the circumference of the flange. The tank cap that screws into the fill-port nipple of the tank also comprises a flange containing a hole or holes on the circumference of the flange allowing a lock to be installed into a hole of the tank fill-port nipple flange and also through an aligned hole of the tank cap flange, therefore preventing the tank cap from being opened at the tank fill-port. This style of a locking fuel tank cap is usually factory installed with the flange welded on the tank during the tank construction and is referred to as a “locking flange tank cap”.

Another current design of a locking tank cap on a diesel fuel tank is wherein a lockable housing is placed over the cap preventing access to the tank cap to remove the tank cap. This type of device is usually called a locking fuel cap cover that covers the existing fuel cap and can freely spin around the existing tank cap preventing the existing tank cap from being unscrewed from the tank fill-port. This style of a locking tank cap leaves the existing tank cap in place and is referred to as a “locking tank cap cover”.

And still another current design of a locking tank cap on a diesel fuel tank is wherein the original tank cap is replaced with an aftermarket tank cap that employs a locking device built into the tank cap and prevents the tank cap form being removed from the tank fill-port. This style of a locking fuel tank cap replaces the existing fuel tank cap and is referred to as a “after market lockable tank cap”.

The above three types of lockable tank cap devices in the marketplace today may have certain disadvantages to the end user of the product.

The “locking flange tank cap” is a configuration of the locking device that is generally welded to the fill port nipple of a tank such as a fuel tank. Performing any type of welding on a fuel tank requires special precautions to be taken such and removing the tank from the vehicle and prepping the tank with no fuel or fuel vapors in the tank to prevent a catastrophic event such as a fire or explosion. This locking flange cap configuration is generally installed at the time the tank is manufactured, and before fuel has been added to the tank.

The “locking tank cap cover” is a single collar configuration lockable device that prevents access to the tank cap. This style of a lockable device always is provided with a lock and key from the manufacturer of the device. The lock provided is an integral part of the lockable device, therefore the end user of the device does not have the option of providing his or her own lock for the device, in addition, the lock for the device is not easily or quickly replaced if need be in a situation as a damaged lock from an attempted theft of the contents in a tank.

The “after-market lockable tank cap” replaces the factory installed tank cap that usually is provided with the tank such as a fuel tank on a vehicle. The factory installed fuel tank cap is usually a high quality tank cap that has been tested and approved for the individual vehicle. Buying an after-market fuel tank cap can be problematic if the after-market tank cap has not been properly tested and approved by a competent authority. In addition, as in the same case as the “locking tank cap cover”, the provided lock is an integral part of the lockable device, therefore the end user of the device does not have the option of providing his or her own lock for the device, in addition, the lock for the device is not easily or quickly replaced if need be in a situation as a damaged lock from an attempted theft of the contents in a tank.

### SUMMARY OF THE INVENTION

The disclosed invention relates to preventing access or removal of a tank fill-port cap such as a fill-port cap on a tank wherein the tank fill-port cap is attached to a fill-port nipple, the fill-port nipple being the inlet of product into the tank. The utility and uniqueness of the disclosed invention is securing and locking in place a lockable blocking device that prevents the tank's original non-locking fill-port cap from being opened by an unauthorized person. The disclosed invention utilizes two collars, a first collar and a second collar, the first collar with a first attachment means attaching the first collar to the tank fill-port nipple while also the first collar comprises a second attachment means attaching to a lockable blocking device. The second collar covers and protects the first collar's first attachment means to the tank fill port nipple, and the first collar second attachment means to the lockable blocking device securely holds and maintains the position of the second collar preventing the first collar from being removed from the tank fill port nipple, therefore preventing unauthorized access to remove the tank fill port cap when the lockable blocking device is in place and secured.

The disclosed invention titled “Dual collar tank cap locking device” has particular advantages over the previously mentioned three current lockable cap devices in the marketplace today. The disclosed invention can be used to lock a tank cap on any item that comprises a fill port nipple and cap. Advantages of the disclosed invention over the current lockable tank cap devices in the marketplace today are:
The installation or removal of the “dual collar tank cap locking device” is non-permanent, easy, and quick, and can be performed with basic hand tools such as a screwdriver with a Philips or Allen-head tip, there is no need for welding or any type of permanent attachment means. The disclosed invention uses a removable attachment means such as setscrews attaching the first collar to the fill port nipple for a continuous collar, and a clamp screw or clamp screws for attaching the first collar to the fill port nipple for a split collar.
The lockable blocking device that may be used for the disclosed invention is a readily available lock used in the marketplace today, the lock comprising a shackle such as a U-shaped shackle padlock, pin and barrel padlock, or even a hidden shackle lock in a hockey puck configuration may be used. The preferred lock is easily replaceable, and in multiple devices used by the same end user, the multiple locks can be easily keyed alike directly from the lock manufacturer or fitted with new key configurations by a local locksmith. In the case of the hockey puck style lock which may be considered the most secure locking device for this application, the lock may be replaced on the second collar even if the lock is welded to the second collar. The second collar can be removed from the first collar attached to the tank and placed in an area away from the fuel tank, the lock can then be removed from the second collar by removing the weld from the lock and the second collar with a tool such as a metal grinder, and the new lock can be safely welded in place on the second collar in an area away from the tank.
Using the disclosed invention allows the use of the factory installed fill-port tank cap on a vehicle fuel tank. There is no need to replace the factory installed fill-port tank cap.

The disclosed invention is shown with three different versions of the invention with subversions within the versions, although the invention is not limited to these three versions or subversions of the invention. The uniqueness of the invention is the double collar structure of the invention and the utility of the lockable blocking device that locks into the first collar and locks in place the second collar that covers and blocks the removal of the attachment of the first collar to the tank fill-port nipple. The lockable blocking device prevents the opening of the tank fill-port cap by either blocking the removal motion of the cap or blocking access to the cap. As long as the lockable blocking device is in place and in the locked position, the second collar is locked in position covering the first attachment means of the first collar and allowing the second collar or the lockable blocking device to keep the tank fill port cap in the closed position, while also maintaining the attached position of the first collar to the tank fill port nipple.

The three versions of the invention are:
Version-one: The first collar comprises a single attachment bar with a single hole wherein the lockable blocking device attaches to. The second collar fits under the lockable blocking device and is confined in position by the lockable blocking device. The lockable blocking device also acts as a restricting device restricting the movement of the second collar wherein excess movement of the second collar would expose the first collar attachment screw or screws to the fill port nipple to tampering or removal. The lockable blocking device is also used to i) restrict the removal movement of the tank fill-port cap, or ii) restrict access to the tank fill-port cap, or iii) both restrict the removal movement of the tank fill-port cap and restrict access to the tank fill-port cap.
Version-two: The first collar comprises a two separate attachment bars with a single hole in each attachment bar wherein the lockable blocking device attaches to. The lockable blocking device inserts through both holes of the attachment bars. The second collar fits under the lockable blocking device and is confined in position by the lockable blocking device. The lockable blocking device also acts as a restricting device restricting the movement of the second collar wherein excess movement of the second collar would expose the first collar attachment screw or screws to the fill port nipple to tampering or removal. The lockable blocking device is also used to i) restrict the removal movement of the tank fill-port cap, or ii) restrict access to the tank fill-port cap, or iii) both restrict the removal movement of the tank fill-port cap and restrict access to the tank fill-port cap.
Version-three: The first collar comprises a separate curved attachment bar with two separate holes wherein the lockable blocking device attaches to. The lockable blocking device that attaches to the two separate holes is used to restrict the removal movement of the tank fill-port cap. The lockable blocking device also acts as a restricting device restricting the movement of the second collar wherein excess movement of the second collar would expose the first collar attachment screw or screws to the fill nipple to tampering or removal. The lockable blocking device is also used to restrict the removal movement of the tank fill-port cap.

Another feature of the invention is an attachment method of attaching the first collar to the tank fill-port nipple without causing damage to the tank fill-port nipple, while still maintaining a very tight and secure pressure on setscrew heads in a countersunk hole that will not loosen when applied to a vehicle fuel tank of a truck. The attachment method comprises a method of maintaining a very tight hold on a countersunk setscrew head by supplying sufficient torque to the setscrew head when the setscrew head seats into the countersunk hole. The length of the setscrews can be measured and limited to allow only a required length of the set screw to protrude out of the nipple side of the first collar to pressure against the nipple with sufficient but not excessive pressure force against the nipple. The screw head seats in the countersunk hole limiting the length of the screw protruding out of the first collar towards the fill port nipple, or a simple countersunk, non-seating screw head application can be used to hold the first collar attachment to the fill port nipple.

Another method of attaching the first collar to the tank fill-port nipple is using a split collar that clamps around the fill port nipple and presses down against the circumference of the fill port nipple when tightened. The split collars can be used in a single, double, or triple split collar configuration depending on the style of the fill port nipple. Each split collar has different advantages and disadvantages over the other split collars. The split collars may be the preferred attachment method for tank fill port nipples if there is a concern of the wall strength of the nipple. A fill port nipple with no top flange can use the continuous collar or the single split collar for the first collar attachment to the tank fill port nipple, the first collar can simply slide over the nipple for positioning for attachment. In the event, the tank fill port nipple comprise a top flange and wherein the top flange has a greater diameter than the portion of the fill port nipple the first collar will attach to, the double split collar or the triple split collar is required to be used as a first collar. The triple split collar can be used more effectively on various tank fill port nipples that are close in diameter, the triple split collar and its three clamping pieces allow a tight fit on variable diameters of collars that are close in sized diameters.

### BRIEF DESCRIPTION OF THE DRAWINGS

FIG. 1 is a prior art side view of a diesel fuel tank showing a fuel tank fill-port nipple with a cap.

FIG. 2 is a side view of the diesel fuel tank of FIG. 1 shown with version-one of the disclosed invention installed on the fuel fill-port nipple. The tank fill port cap does not comprise a pressure release device.

FIG. 3 is a side view of the diesel fuel tank of FIG. 1 shown with version-one of the disclosed invention installed on the tank fuel fill-port nipple. The tank fill port cap comprises a pressure release device.

FIG. 4 is a top cutout view of the version-one of the invention showing the first collar and the second collar with other aligned components of the invention. The first collar is a continuous collar with set-screws.

FIG. 5 is a top cutout view of the version-two of the invention showing the first collar and the second collar with other aligned components of the invention. The first collar is a continuous collar with set-screws.

FIG. 6 is a top cutout view of the version-one of the invention showing the first collar and the second collar with other aligned components of the invention. The first collar is a single split collar.

FIG. 7 is a perspective view of version-one of the invention showing the first collar, tank fill-port nipple, tank fill-port cap, and the single first collar attachment bar.

FIG. 8 is a perspective view of version-one of the invention showing the first collar, tank fill-port nipple, tank fill-port cap, the single first collar attachment bar, the second collar and a lockable blocking device is a padlock.

FIG. 9 is a top cutout view of the version-one of the invention showing the first collar and the second collar with other aligned components of the invention. The first collar is a single split collar. The tank fill port cap has a pressure release device.

FIG. 10 is a perspective view of version-one of the invention showing the first collar, tank fill-port nipple, tank fill-port cap, the single first collar attachment bar, and a lockable blocking device in a padlock. The first collar is a single split collar. The attachment bar hole is drilled at an angle that is great enough of an angle to require the lockable attachment device will allow the tank cap pressure release device to open. The drawing is shown without the second collar attached to allow the view of the first collar.

FIG. 11 is a perspective view of FIG. 10 with the second collar attached.

FIG. 12 is a perspective view of the first collar of the first version of the invention without the second collar attached, showing a continuous first collar with setscrews attaching the first collar to the tank fill port nipple.

FIG. 13 is a side view of version-one of the first collar showing a continuous first collar with setscrews attaching the first collar to the fill port nipple.

FIG. 14 is a side view of version-one of the invention showing a continuous first collar with setscrews attaching the first collar to the fill port nipple. Also showing is the second collar with a hood cover and a hidden shackle lock attached as the lockable blocking device.

FIG. 15 is a perspective view of version-one of the invention without the second collar with enclosing device hood and flat top attached and showing a single split first collar.

FIG. 16 shows FIG. 15 with the second collar with enclosing device hood and flat top installed without a lockable blocking device installed.

FIG. 17 shows FIG. 16 with the lockable blocking device installed using a padlock.

FIG. 18 is a side view of version-two of the invention without the second collar, showing the continuous collar with setscrews attaching the first collar to the fill port nipple, also showing the first collar attachment bars.

FIG. 19 is a perspective view of version-two of the invention without the second collar, showing the continuous collar with setscrews attaching the first collar to the fill port nipple, also showing the first collar attachment bars.

FIG. 20 shows FIG. 19 with an outline of the second collar.

FIG. 21 is a perspective view of version-two of the invention without the second collar showing the single split first collar installed around the fill port nipple.

FIG. 22 is a perspective view of version-two of the invention without the second collar showing the double split first collar installed around the fill port nipple.

FIG. 23 is a perspective view of version-two of the invention without the second collar showing the triple split first collar installed around the fill port nipple.

FIG. 24 is a perspective view of version-two of the invention without the second collar showing the single split first collar installed around the fill port nipple with a forward view of the first collar clamp screw.

FIG. 25 is a perspective view of version-two of the invention showing the second collar around the first collar without the lockable blocking device installed.

FIG. 26 shows FIG. 25 with the lockable blocking device installed using a padlock.

FIG. 27 shows FIG. 25 with the lockable blocking device installed using a pin and barrel lock.

FIG. 28 is a top cutout view of version-two of the invention in a single split collar application.

FIG. 29 is a perspective view of version-two of the invention without the second collar installed, showing the two first collar attachment bars.

FIG. 30 is a perspective view of version-two of the invention showing the two first collar attachment bars protruding through the second collar with enclosing device hood and flat top and a padlock installed as the lockable blocking device.

FIG. 31 is a top cutout view of version-two of the invention in a single split collar application and a tank fill port cap pressure relief device in the center of the cap.

FIG. 32 is a frontal view of version-two of the invention without the second collar installed, showing the first collar attachment bars in a differing length when compared to each other and the first collar second means for attachment.

FIG. 33 shows FIG. 32 with the second collar installed.

FIG. 34 is a perspective view of version-two of the invention without the second collar installed, showing the first collar attachment bars in a differing length when compared to each other and the first collar second means for attachment.

FIG. 35 is a top cutout view of version-one of the invention with only one first collar attachment bar, and showing spacers attached to the first collar to provide for a larger diameter hood top of the second collar.

FIG. 36 is a perspective view of FIG. 34 showing the first collar spacers.

FIG. 37 is a perspective view of FIG. 35 showing the second collar with enclosing device hood and flat top installed.

FIG. 38 is a perspective view of FIG. 36 showing a transparent view of the lockable blocking device hockey puck style lock installed in the first collar attachment bar hole.

FIG. 39 is a perspective view of FIG. 37 showing the hockey puck lock in a non-transparent view.

FIG. 40 is a top cutout view of version-two of the invention with two first collar attachment bars showing spacers attached to the first collar to provide for a larger diameter hood top of the second collar.

FIG. 41 is a perspective view of FIG. 39 showing the first collar spacers without the second collar installed.

FIG. 42 is a perspective view of FIG. 40 showing the second collar with enclosing device hood and flat top installed.

FIG. 43 is a perspective view of FIG. 42 showing a transparent view of two hockey puck style locks installed in the first collar attachment bars hole providing the lockable blocking devices.

FIG. 44 is a perspective view of FIG. 43 showing the two hockey puck locks in a non-transparent view.

FIG. 45 is a top cutout view of version-one of the invention with only one first collar attachment bar and an added second collar support bar, and showing no spacers attached to the first collar. The drawing also showing a pressure relief device installed in the center of the tank fill port cap.

FIG. 46a is a side view of the second collar with enclosing device hood and sloped top outline installed over the first collar with a hockey puck style lock installed as a lockable blocking device and hood supports near the top of the hood.

FIG. 46b is a side view of the second collar with enclosing device hood and sloped top outline installed over the first collar with a hockey puck style lock installed as a lockable blocking device and hood supports near the bottom of the hood.

FIG. 47 is a side view of the second collar with enclosing device hood and sloped top in a transparent view installed over the first collar with a hockey puck style lock installed as a lockable blocking device. Also showing the first collar attachment bar in a bent configuration.

FIG. 48 is a perspective non-transparent view of FIG. 46 without the hockey puck lock installed as the lockable blocking device.

FIG. 49 is a perspective non-transparent view of FIG. 46 with the hockey puck lock installed as the lockable blocking device.

FIG. 50 is a top cutout view of version-two of the invention with two first collar attachment bars of different lengths, and showing no spacers attached to the first collar. The drawing also showing a pressure relief device installed in the center of the tank fill port cap.

FIG. 51 is a perspective view of version-two of the invention without the second collar installed, showing the first collar attachment bars in differing lengths when compared to each other and the first collar second means for attachment positioned at a differing angle when compared to the angle of the tank fill port cap top surface preventing the blocking device from blocking the opening of a cap centered fill port cap pressure release.

FIG. 52 is a perspective view of FIG. 50 showing the second collar with enclosing device hood and sloped top outline installed under the padlock used as a lockable blocking device.

FIG. 53 is a perspective view of the third version of the invention without the second collar installed and showing the first collar curved attachment bar comprising two attachment holes. Also showing the single split first collar clamp screw.

FIG. 54 is another slightly rotational turned view of FIG. 52 showing both first collar attachment bar holes.

FIG. 55 shows FIG. 54 with the second collar installed and no lockable blocking device installed.

FIG. 56 is a top cutout view of the third version of the invention with both the first and the second collar installed and showing a padlock installed as the lockable blocking device.

FIG. 57 is a perspective view of version-two of the invention without the second collar installed, showing the two first collar attachment bars. Also showing the tank fill port nipple with an attached top flange.

FIG. 58 is a frontal view of version-two of the invention without the second collar installed. This drawing is the same drawing as FIG. 32 with items 23a, 23b, 23c and 23d being added to the drawing.

FIG. 59 is the same drawing of FIG. 58 turned at a thirty-degree angle in a counter clockwise rotation.

FIG. 60 is a frontal view of version-two of the invention without the second collar and a padlock installed. The second collar is not shown.

FIG. 61 is a perspective view of version-two of the invention showing the frontal view of FIG. 60 turned at an approximately forty-five degree angle, while also showing the frontal plane (side to side) in the drawing.

FIG. 62 is a perspective view of version-two of the invention showing the frontal view of FIG. 60 turned at an approximately forty-five degree angle, while also showing the Sagittal plane (front to back) in the drawing.

FIG. 63 is a perspective view of version-two of the invention showing the frontal view of FIG. 60 turned at an approximately forty-five degree angle, while also showing the Transverse plane (horizontal) in the drawing.

FIG. 64 is a frontal view of version-one of the invention without the second collar and a padlock installed. The second collar is not shown.

FIG. 65 is a perspective view of version-one of the invention showing the frontal view of FIG. 64 turned at an approximately forty-five degree angle, while also showing the frontal plane (side to side) in the drawing.

FIG. 66 is a perspective view of version-one of the invention showing the frontal view of FIG. 64 turned at an approximately forty-five degree angle, while also showing the Sagittal plane (front to back) in the drawing.

FIG. 67 is a perspective view of version-one of the invention showing the frontal view of FIG. 64 turned at an approximately forty-five degree angle, while also showing the Transverse plane (horizontal) in the drawing.

FIG. 68 is a perspective view of version-two of the invention showing the frontal view of FIG. 60 turned at an approximately forty-five degree angle, while also showing the plane the lock shackle is positioned in FIG. 60.

FIG. 69 is a perspective view of version-two of the invention showing the frontal view of FIG. 64 turned at an approximately forty-five degree angle, while also showing the plane the lock shackle is positioned in FIG. 64.

### DETAILED DESCRIPTION OF THE INVENTION

### Reference Numerals

For the convenience of the reader, the following is a list of reference numbers used in the detailed description and the drawings:
1 Dual collar tank cap locking device
2 Fuel tank system
4 Tank
6 Fill-port
8 Fill-port cap
9 Fill-port cap pressure release device
10 Fill-port nipple
11 Fill-port nipple flange
12 Vent-port
14 Vent-port nipple
16 Vent-port tube
18 Fuel type designation
19 First collar—slice
20 First collar
20a First collar, continuous circumference
20b First collar, single-split
20c First collar, double-split
20d First collar, triple-split
21 Second collar
21a Second collar with enclosing device hood and flat top
21b Second collar with enclosing device hood and sloped top
22 Second collar base rim
23a First plane (Frontal plane, side to side) or (Sagittal plane, front to back)
23b Second plane (Transverse plane)
23c Third plane (lock shackle plane)
23d degrees angle difference (of the second plane compared to the third plane)
24 First collar attachment bar
25 First collar first means of attachment—setscrews
26 First collar first means of attachment—clamp screws
27 First collar—clamp screw threads
28 First collar—clamp screw head opening
29 First collar second means for attachment (attachment bar hole)
30 Second collar stabilizing screws
32 Lockable blocking device
32a Lockable blocking device (padlock)
32b Lockable blocking device (hidden shackle lock) (hockey puck shaped)
32c Lockable blocking device (barrel and pin lock)
37 Lock keyway
38 Lock shackle
40 Lock shackle (hidden)
41 Shackle set pin
42 Padlock shackle heel
44 Padlock shackle toe
46 Padlock shackle U-Shaped head
48 Lock shackle pin
49 Lock shackle pin stop device
50 Padlock body
52 Barrel lock body
54 Second collar hood top
56 Second collar hood top opening
58 First collar spacer
60 Second collar support bar
62 Second collar support plate
64 First collar curved attachment bar

FIG. 1 is a prior art side view of a diesel fuel tank system 2 showing the tank 4 fuel fill-port 6 comprising the fuel fill-port nipple 10 and the fill-port cap 8. Additionally showing the vent-port 12 with the vent-port nipple 14, the vent-port tube 16, and the fuel type designation 18.

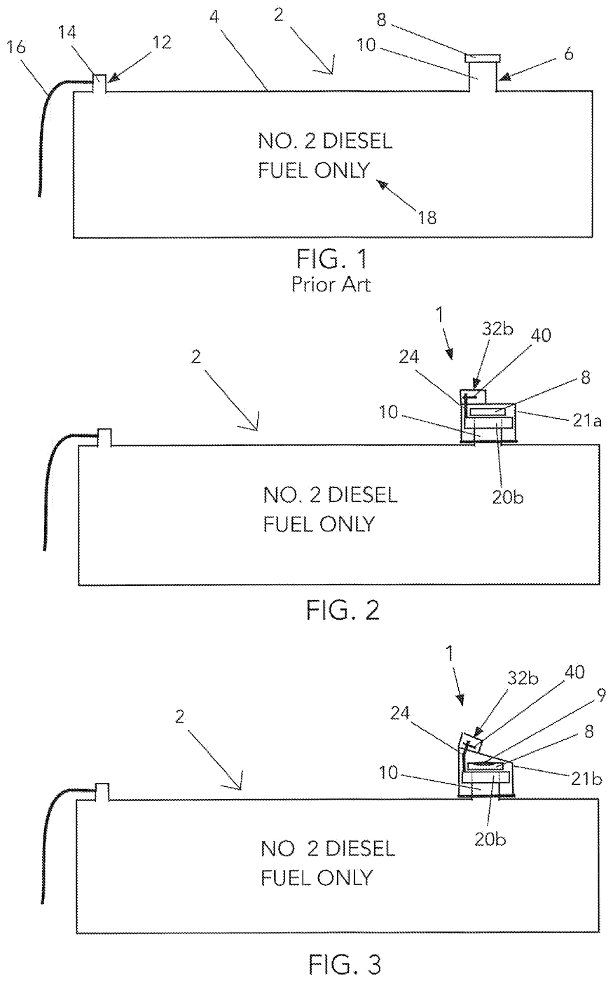

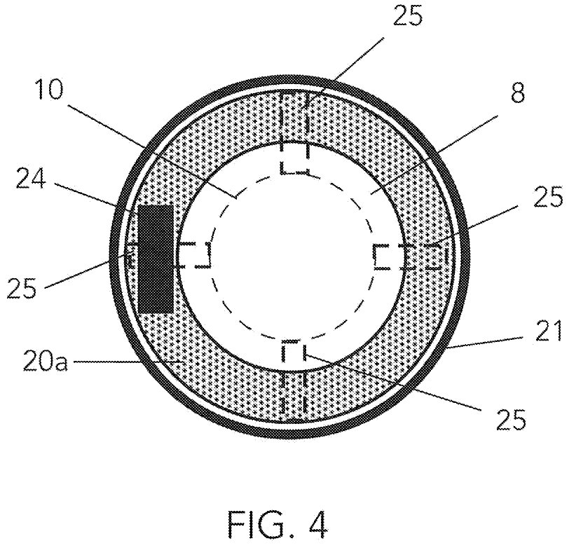

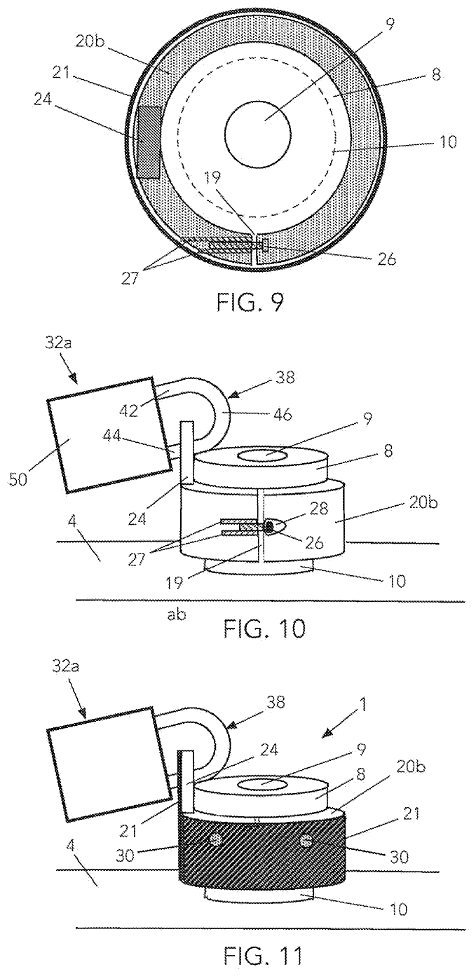

FIG. 2 is a side view of the diesel fuel tank system 2 of FIG. 1 shown with version-one of the disclosed invention installed on the fuel fill-port nipple 10, the first collar comprises a single attachment bar with a single hole that the lockable blocking device attaches to. The tank fill port cap 8 does not comprise a pressure release device 9 (see FIG. 3 and FIG. 10), therefore, the second collar 21a flat hood may be positioned very close to or on top of the fill port cap 8. The first collar 20 is shown in a cutout drawing with the tank fill-port nipple 10 in the center of the first collar 20. The first collar 20 first means for attachment is either setscrews 25 (not shown see FIG. 4) to attach the first collar to the tank fill-port nipple 10 or a split collar attachment to the tank fill-port nipple 10 using a clamp screw 26 (not shown see FIG. 9) to clamp the first collar 20 around the tank fill-port nipple 10. The setscrews 25 (not shown see FIG. 4) can normally employ a blunt tip of the setscrew 25 to secure the first collar 20 to the tank fill-port nipple 10. The second collar with hood 22a is shown covering the fill-port cap 8 and the first collar 20. The first collar 20b is shown with the attachment bar 24 protruding through the second collar with flat hood 21a. The lockable blocking device 32b is a hidden shackle lock in a hockey puck style lock wherein the hidden shackle 40 attaches to the first collar attachment bar 24, therefore holding the second collar with flat hood 21a securely in place. The second collar with flat hood 21a prevents access to the tank fill port cap 8, therefore preventing the tank fill port cap 8 from being removed. The second collar with flat hood 21a also prevents access to the first collar first means of attachment 25, 26 being a clamp screw 26 or setscrew or setscrews 25 (not shown).

FIG. 3 is a side view of the diesel fuel tank of FIG. 1 shown with version-one of the disclosed invention installed on the fuel fill-port nipple, the first collar comprises a single attachment bar with a single hole that the lockable blocking device attaches to. The tank fill port cap comprises a pressure release device. FIG. 3 is similar to FIG. 2 except the second collar with enclosing device hood with enclosing device hood and sloped top 21b is configured in a sloped hood style to accommodate a fill cap pressure relief device 9. The sloped top of the second collar with enclosing device hood and sloped top 21b allows the fill cap pressure relief device 9 to open without touching the second collar with enclosing device hood and sloped top 21b sloped top even if the bottom edge of the second collar with enclosing device hood and sloped top 21b sloped top is resting on the edge of the fill port cap 8. Version two and version three of the disclosed invention is recommended for all fill port caps 8 with a pressure relief device 9 located in the center of the fill port cap 8. If the fill port cap employs a pressure relief device 9 and the pressure relief device 9 is located near the edge of the fill port cap 8, the mounting of the first collar 20 must be positioned so that the second collar 20 or the lockable blocking device 32 does not impede the opening of the pressure relief device 9.

FIG. 4 is a top cutout view of version-one of the disclosed invention installed on the tank fill-port nipple 10, the first collar comprises a single attachment bar with a single hole that the lockable blocking device attaches to. Showing the first collar 20 and the second collar 21 with other aligned components of the invention. The first collar 20 is a continuous collar 20a with setscrews 25. The fill port tank cap 8 is shown with a cutout view of the fill port nipple 10 as a dotted line. The first collar attachment bar 24 is shown attached to the first collar 20.

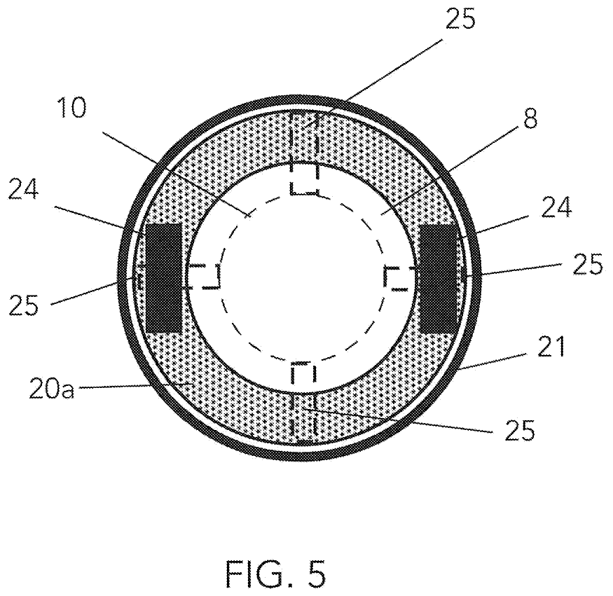

FIG. 5 is a top cutout view of version-two of the invention showing all of the components of FIG. 4 with the addition of the additional first collar attachment bar 24 thereby comprising two first collar attachment bars 24. The first collar 20a comprises a first means for attachment 25 such as setscrews to removably attach the first collar 20a to the tank fill-port nipple 10, the first collar 20a first means for attachment 25 to the tank fill port nipple 10 being adjustable setscrews applying pressure from the first collar 20 to the wall of the tank fill port nipple 10 resulting in a tight, rigid, and non-movable condition of the first collar 20a around the tank fill port nipple 10.

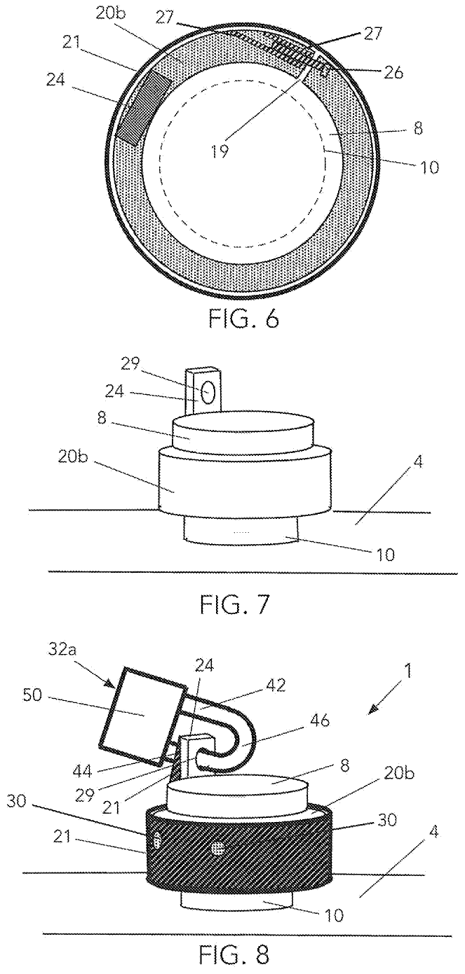

FIG. 6 is a top cutout view of version-one of the disclosed invention showing the first collar 20b and the second collar 21 with other aligned components of the invention. The first collar 20b is a single split collar 20b, the single first collar attachment bar 24 is shown attached to the first collar 20b. The tank fill port cap 8 is shown with a cutout view of the tank fill port nipple 10 as a dotted line. The first collar clamp screw 26 is shown threaded inside the first collar clamp screw threads 27 with the first collar slice 19 shown. The first collar 20b is shown as a single split collar 20b to be compressed around the fill port nipple 10. The compression of the first collar 20b is achieved using the first collar clamp screw 28 tightened into the first collar clamp screw threads 27 to compress the first collar slice 19. The first collar 20b comprises a first means for attachment 26 such as clamp screws to removably attach the first collar 20b to the tank fill-port nipple 10, the first collar first means for attachment to the tank fill port nipple being adjustable clamp screws applying pressure from the first collar 20b to the wall of the tank fill port nipple 10 resulting in a tight, rigid, and non-movable condition of the first collar 20 around the tank fill port nipple 10.

FIG. 7 is a perspective view of version-one of the disclosed invention without the second collar 21 attached. Showing the invention installed on the tank fill-port nipple 10, the first collar 20b comprises a single attachment bar 24 with a single hole 29 that the lockable blocking device 32a (no shown, see FIG. 8) attaches to. Showing the invention attached to the tank 4 fill-port nipple 10 and showing the first collar 20b, tank fill-port cap 8 and the single first collar attachment bar 24. Inside the single first collar attachment bar 24 is the first collar second means for attachment 29 being a hole.

FIG. 8 is a perspective view of version-one of the disclosed invention installed on the tank fill-port nipple 10, the first collar 20b comprises a single attachment bar 24 with a single hole 29 that the lockable blocking device 32a attaches to. Showing the disclosed invention with an attached second collar 21 and attached lockable blocking device 32a comprised of a padlock. FIG. 8 showing the first collar 20b surrounded by the second collar 21, tank 4 fill-port nipple 10, tank fill port cap 8, the single first collar attachment bar 24, and the second collar 21 against the first collar attachment bar 24. The second collar 21 is shown with two stabilizer screws 30 that stabilizes the second collar 21 on the first collar 20b to prevent minor movements of the second collar 21 even though the lockable blocking device 32a holds the second collar 21 in a secure position around the first collar 20b, therefore, securing the first collar 20b first means of attachment clamp screw 26 (see FIG. 6). The lockable blocking device padlock 32a fits through the first collar 20b second means of attachment 29 hole in the first collar attachment bar 24, and is shown with the padlock body 50, shackle heel 42, shackle toe 44, and shackle U-Shaped head 46

FIG. 9 is a top cutout view of version-one of the invention similar to FIG. 6 with the addition of the tank fill port cap 8 pressure relief device 9. Showing the first collar 20b and the second collar 21 with other aligned components of the invention. The first collar is a single split collar 20b. The tank fill port cap 8 is shown with a cutout view of the fill port nipple 10 as a dotted line. The first collar slice 19 is shown where the first collar clamp screw 26 and the first collar clamps screw threads 27 are located. The second collar 21 is shown surrounding the first collar 20b with the first collar attachment bar 24 attached to the first collar 20b. The first collar 20b is shown as a single split collar 20b to be compressed around the tank fill port nipple 10. The compression of the first collar 20b is achieved using the first collar clamp screw 28 tightened into the first collar clamp screw threads 27 to compress the first collar slice 19.

FIG. 10 is a perspective view of version-one of the invention without the second collar 21 attached. Showing the first collar 20b, tank fill-port nipple 10, tank fill port cap 8 with pressure relief device 9 in the center of the cap 8, the single first collar attachment bar 24, and a lockable blocking device 32 in a padlock 32a with padlock body 50 and shackle 38 attached through the first collar attachment bar hole 29 (see FIG. 7). The first collar 20 is a single split collar 20b. The attachment bar hole 29 is directed at an angle that is great enough of an angle to require the lockable attachment device 32a shackle toe 44 will allow the tank fill port cap 8 pressure relief device 9 to open and relive pressure in the tank 4. The drawing is shown without the second collar not attached to the first collar to allow the view of the first collar. The proper configuration of the dual collar tank cap locking device 1 (see FIG. 11) is a first collar 20, mounted to the tank fill port nipple 10 and a second collar 21 (see FIG. 11) protecting the first collar attachment means 26 to the tank fill port nipple 10. The first collar slice 19 is shown where the first collar clamp screw 26 and the first collar clamps screw threads 27 are located, the first collar clamp screw opening 28 provides the passage way for the clamp screw 26 to enter through the first collar slice 19 to attach to the first collar clamps screw threads 27.

FIG. 11 is a perspective view of FIG. 10 with the second collar 21 attached completing a version of the dual collar tank cap locking device 1. The second collar is shown attached to the first collar 20b with stabilizing screws 30. The purpose of the stabilizing screws 30 is to hold the second collar 21 in place, although the stabilizing screws 30 are not a secure attachment means of the second collar 21, the secure attachment means of the second collar 21 is the lockable blocking device padlock 32a. With the shackle 38 of the padlock 32a attached through the first collar second means for attachment, attachment bar 24 hole 29 (see FIG. 7), the second collar is securely held in place and covering the first collar first attachment means clamp screw 26 preventing the first collar 20b from being removed from the tank 4 fill port nipple 10. The position of the padlock 32a shackle 38 being positioned away from the fill port cap 8 pressure relief device 9.

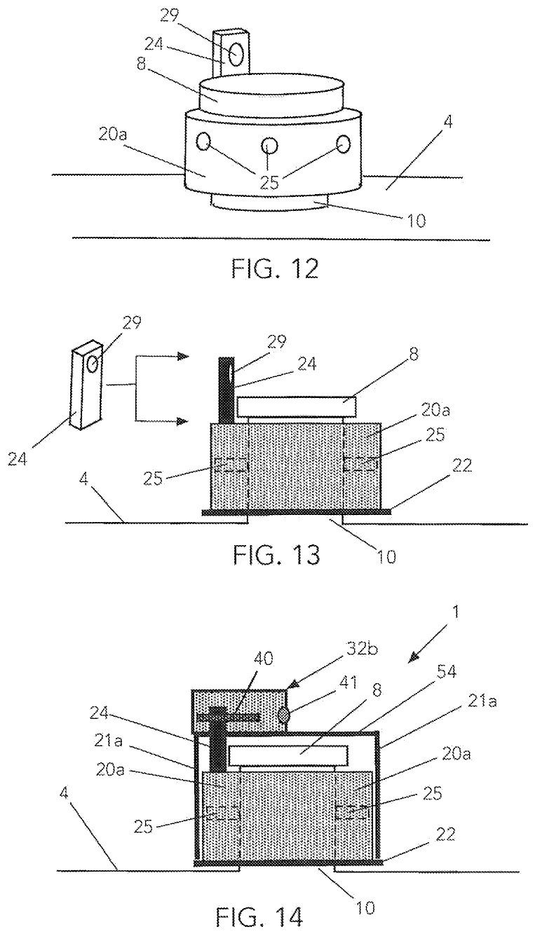

FIG. 12 is a perspective view of the first collar 20a of version-one of the invention without the second collar 21 attached, and showing a continuous first collar 20a with setscrews 25 attaching the first collar 20a to the fill port nipple 10. Setscrews 25 are shown threaded into the first collar 20a securely holding the first collar 20a in place on the inlet nipple 10 of the tank 4. The first collar 20a attachment bar 24 is shown with the first collar second means of attachment 29 shown as a hole 29 in the first collar attachment bar 24. The fill port cap 8 located just above the first collar 20a.

FIG. 13 is a side view of the first collar 20a of version-one of the invention without the second collar 21 attached showing a continuous first collar 20a with setscrews 25 attaching the first collar 20a to the fill port nipple 10. Setscrews 25 are shown threaded into the first collar 20a securely holding the first collar 20a in place on the inlet nipple 10 of the tank 4. The first collar 20a attachment bar 24 is shown with the first collar second means of attachment 29 shown as a hole 29 in the first collar attachment bar 24. The fill port cap 8 located just above the first collar 20a, the first collar attachment bar 24 shown not in contact with the tank fill port cap 8. Below the first collar 20a is a second collar base rim 22 for support of the second collar with flat hood 21a (see FIG. 14).

FIG. 14 is a side view of version-one of the invention with the second collar 21 attached completing a version of the dual collar tank cap locking device 1 attached to a tank fill port nipple 10. Showing the first collar 20a and the second collar with flat hood 21a of the invention and a lockable blocking device 32b in a hockey puck style lock with a hidden shackle 40 and shackle set pin 41, the hidden shackle 40 protruding through the first collar attachment bar 24 hole 29 (see FIG. 13). Also showing the continuous first collar 20a with setscrews 25 attaching the first collar 20a to the tank fill port nipple 10. In addition the second collar with flat hood 21a is shown with the lockable blocking device 32b attached to the hood top 54, the second collar mounted on the second collar base rim 22 allowing the second collar hood top 54 to be free of contact with the tank fill port cap 8. The tank fill port cap 8 is shown without a pressure relief device 9 (see FIG. 11) allowing the second collar hood top 54 to be close in proximity to the tank fill port cap 8.

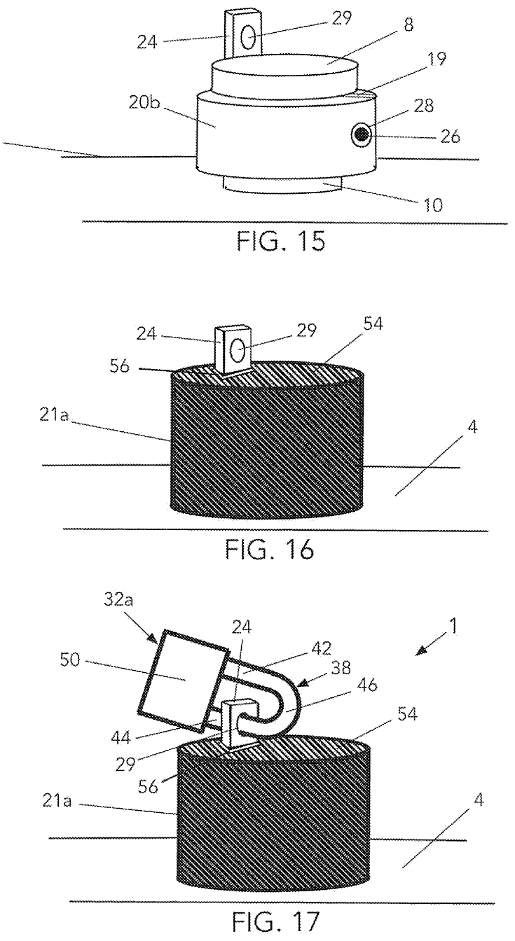

FIG. 15 is a perspective view of the first collar 20b of version-one of the invention without the second collar with enclosing device hood and flat top 21a attached, and showing a single split collar 20b with the first collar clamp screw 26 and the clamp screw head opening 28 attaching the first collar 20b to the tank fill port nipple 10. The first collar 20b slice 19 is positioned on the same side as the clamp screw 26. The first collar attachment bar 24 is shown with the first collar second means of attachment hole 29. The tank fill port cap 8 does not comprise a pressure relief device 9 (not shown, see FIG. 10)

FIG. 16 shows FIG. 15 with the second collar with enclosing device hood and flat top 21a installed over the first collar 20b (see FIG. 15) without a lockable blocking device installed (see FIG. 16). The first collar attachment bar 24 is shown protruding through the first collar hood top 54 opening 56 allowing for a lockable blocking device (not shown) to be installed in the first collar 20b (see FIG. 15) second means of attachment hole 29. The second collar with enclosing device hood and flat top 21a is shown at or near the top of the tank 4.

FIG. 17 shows FIG. 16 with the lockable blocking device 32a installed using a padlock. FIG. 17 is a perspective view of the first version of the invention with the second collar with flat hood 21a mounted around the first collar 20b (not shown, see FIG. 15) completing a version of the dual collar tank cap locking device 1 attached to a tank 4 tank fill port nipple 10 (not shown, see FIG. 15). The first collar attachment bar 24 protrudes through the second collar flat top 54 on the hood top opening 56, the lockable blocking device padlock 32a shackle 38 is shown passing through the first collar attachment bar 24 hole 29 at the shackle toe 44, showing the padlock body 50, the shackle heel 42 being opposite the shackle toe 44 while also showing the shackle U-shaped head 46. The padlock 32a preventing the removal of the second collar with enclosing device hood and flat top 21a from the first collar 20b (not shown, see FIG. 15).

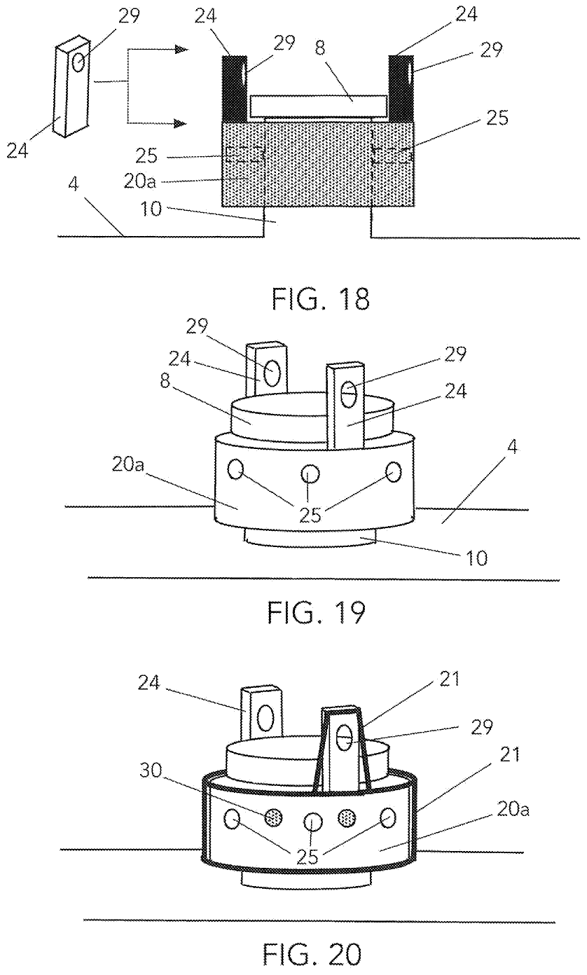

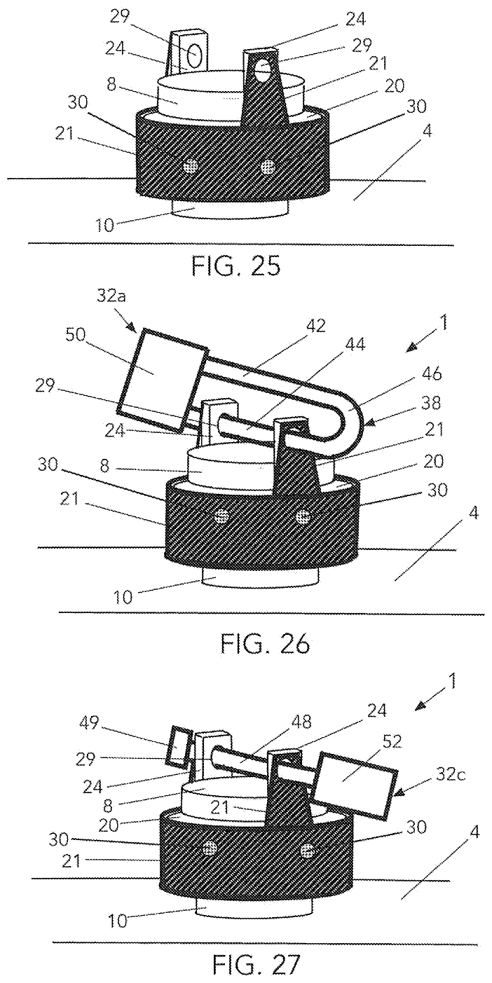

FIG. 18 is a side view of version-two of the invention comprising the first collar 20a two separate attachment bars 24 with a single hole 29 in each attachment bar 24 wherein the lockable blocking device 32a (not shown, see FIG. 26) attaches to. The disclosed invention shown without the second collar 21 (not shown, see FIG. 25) attached showing the continuous first collar 20a with setscrews 25 attaching the first collar 20a to the tank 4 fill port nipple 10, and also showing the first collar attachment bars 24+24 with a first collar second means of attachment holes 29 in each first collar attachment bar 24. The fill port cap 8 is shown positioned between each of the first collar attachment bars 24.

FIG. 19 is a perspective view of version-two of the invention without the second collar 21 (not shown, see FIG. 25) attached, showing the continuous collar 20a with setscrews 25 attaching the first collar 20a to the tank 4 fill port nipple 10, and also showing the first collar attachment bars 24+24 with a first collar second means of attachment holes 29 in each first collar attachment bar 24. The tank fill port cap is shown positioned between each of the first collar attachment bars 24.

FIG. 20 shows FIG. 19 with an outline of the second collar 21 attached in a removable attachment to the first collar 20a with the second collar stabilizing screws 30 to hold the second collar 21 in place (see FIG. 25) when the lockable blocking device (not shown, see FIG. 26) is not installed in the first collar 20a attachment bar 24 hole 29. The second collar 21 is securely attached to the first collar 20a using the first collar second means of attachment hole 29 and a lockable blocking device (not shown, see FIG. 26) is installed in the first collar second means of attachment hole 29.

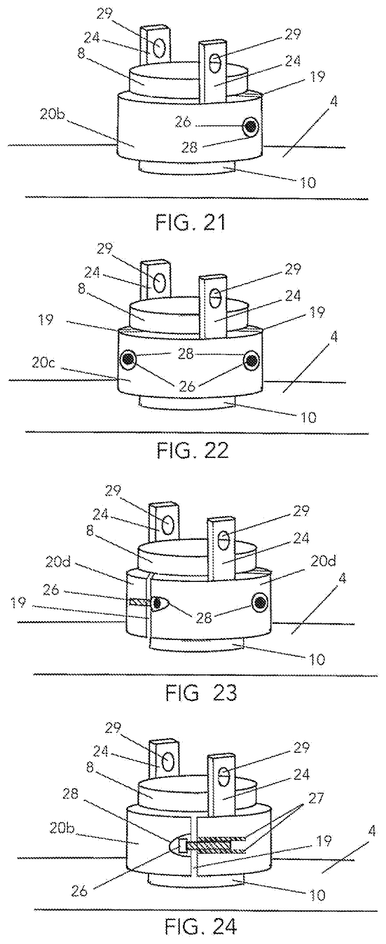

FIGS. 21-23 are perspective views of version-two of the invention without the second collar 21 (not shown, see FIG. 25) attached to the first collars 20b+20c+20d. Each FIG. comprising the first collar 20a two separate attachment bars 24+24 with a single hole 29 in each attachment bar 24 wherein the lockable blocking device 32a (not shown, see FIG. 26) attaches to. The disclosed invention shown without the second collar 21 (not shown, see FIG. 25) FIG. 21 shows the single split first collar 20b installed around the tank fill port nipple 10. FIG. 22 shows the double split first collar 20c installed around the tank fill port nipple 10. FIG. 23 shows the triple split first collar 20d installed around the tank fill port nipple 10. FIGS. 21-23 also shows the first collar slice 19 and the first collar clamp screw 26 inserted into the first collar clamp screw head opening. The first collars 20b, 20c, and 20d are shown as single split collar 20b, double split collar 20c and a triple split collar 20d to be compressed around the fill port nipple 10. The compression of the first collars is achieved using the first collar clamp screw 28 tightened into the first collar clamp screw threads 27 to compress the first collar slice 19.

FIG. 24 is a perspective view of the second version of the invention without the second collar 21 (not shown, see FIG. 25) showing the single split first collar 20b installed around the tank fill port nipple 10 with a forward view of the first collar clamp screw 26 and the first collar clamp screw threads 27.

FIG. 25 is a perspective view of the second version of the invention without the lockable blocking device 32a installed (see FIG. 26) installed while showing the second collar 21 attached around the first collar 20, the first collar 20 attached to the tank fill port nipple 10, and the tank fill port cap 8 positioned between the two first collar attachment bars 24. Without the lockable blocking device 32a installed, the second collar 21 is held in place by the second collar stabilizing screws 30. The second collar 21 is shown rising up and around the first collar attachment bar 24 second means of attachment hole 29 to allow a secure attachment of the second collar 21 to the first collar 20 when the lockable blocking device (not shown) is installed.

FIG. 26 shows FIG. 25 with the lockable blocking device installed using a padlock. FIG. 26 is a perspective view of the second version of the invention with the second collar 21 mounted around the first collar 20 completing a version of the dual collar tank cap locking device 1 attached to a tank fill port nipple 10. The lockable blocking device 32a is shown as a padlock with a padlock body 50, shackle heel 42, shackle head, 46, and a shackle toe 42 that protrudes through each of the first collar second means for attachment 29 being a hole in each first collar attachment bar 24+24. The tank fill port cap 8 being prevented from removal from the tank fill port nipple by the lockable blocking device 32a padlock shackle 38 and the second collar 21 stabilizing screws 30+30 shown installed. The number of stabilizing screws 30 installed for the second collar 21 can vary between two and six depending the amount of stabilizing of the second collar 21 is optimal.

FIG. 27 is similar to FIG. 26 with the exception of the lockable blocking device 32c being a pin and barrel lock instead of a padlock with a U-shaped shackle (see FIG. 26). The pin and barrel lock lockable blocking device 32c comprises a straight shackle 48 and a shackle pin stop device 49 in addition to the barrel lock body 52.

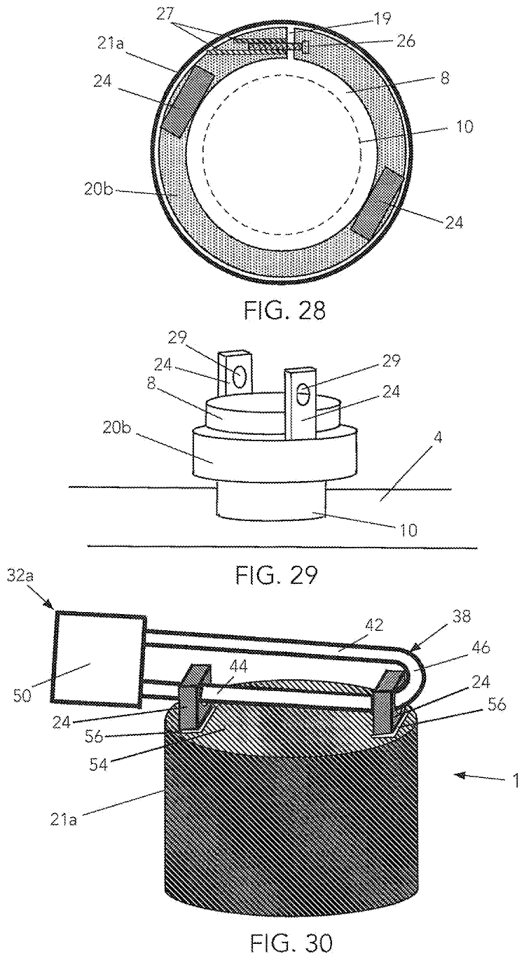

FIG. 28 is a top cutout view of version-two of the invention in a single split collar application showing the first collar 20b and the second collar 21 with other aligned components of the invention. The first collar 20b is a single split collar 20b, the double first collar attachment bar 24+24 is shown attached to the first collar 20b. The tank fill port cap 8 is shown with a cutout view of the tank fill port nipple 10 as a dotted line. The first collar clamp screw 26 is shown threaded inside the first collar clamp screw threads 27 with the first collar slice 19 shown.

FIG. 29 is a perspective view of version-two of the disclosed invention without the second collar 21 attached. Showing the invention installed on the tank fill-port nipple 10, the first collar comprises two attachment bars 24 with a single hole 29 that the lockable blocking device 32a (no shown, see FIG. 30) attaches to. Showing the invention attached to the tank fill-port nipple 10 and showing the first collar 20b, tank fill-port cap 8 and the two first collar attachment bars 24+24. Inside each first collar attachment bars 24+24 are the first collar second means for attachment 29 being a hole.

FIG. 30 is a perspective view of version-two of the invention with the second collar with enclosing device hood and flat top 21a mounted around the first collar 20b (not shown, see FIG. 29) completing a version of the dual collar tank cap locking device 1 attached to a tank fill port nipple 10 (not shown, see FIG. 29). The first collar attachment bars 24 protrude through the second collar flat top 54 on the hood top opening 56, the lockable blocking device padlock 32a shackle 38 is shown passing through each first collar attachment bar 24 hole 29 (see FIG. 29) at the shackle toe 44. Showing the padlock body 50, the shackle heel 42 being opposite the shackle toe 44 while also showing the shackle U-shaped head 46. The padlock 32a preventing the removal of the second collar with enclosing device hood and flat top 21a from the first collar 20b (see FIG. 29).

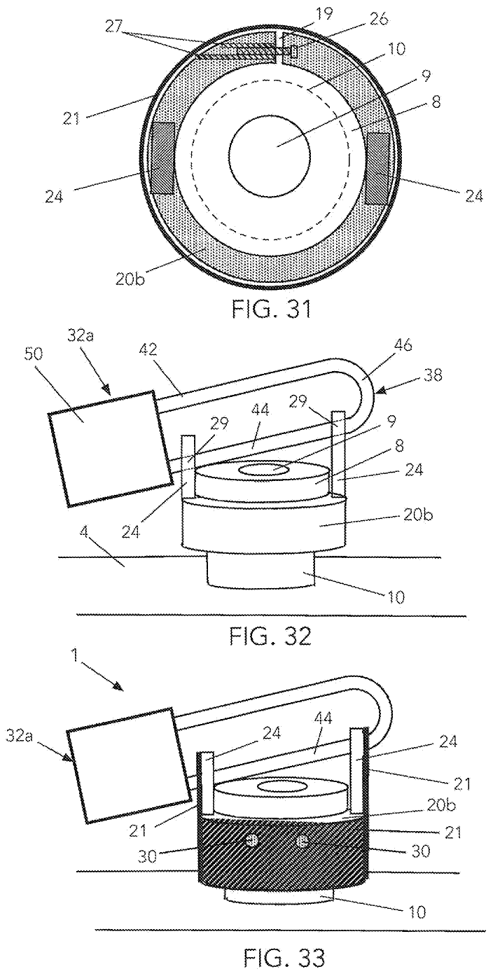

FIG. 31 is a top cutout view of version-two of the invention similar to FIG. 28 in a single split collar application and a tank fill port cap pressure relief device 9 in the center of the cap 8. showing the first collar 20b and the second collar 21 with other aligned components of the invention. The first collar 20b is a single split collar 20b, the two first collar attachment bars 24 are shown attached to the first collar 20b. The tank fill port cap 8 is shown with a cutout view of the tank fill port nipple 10 as a dotted line. The first collar clamp screw 26 is shown threaded inside the first collar clamp screw threads 27 with the first collar slice 19 shown.

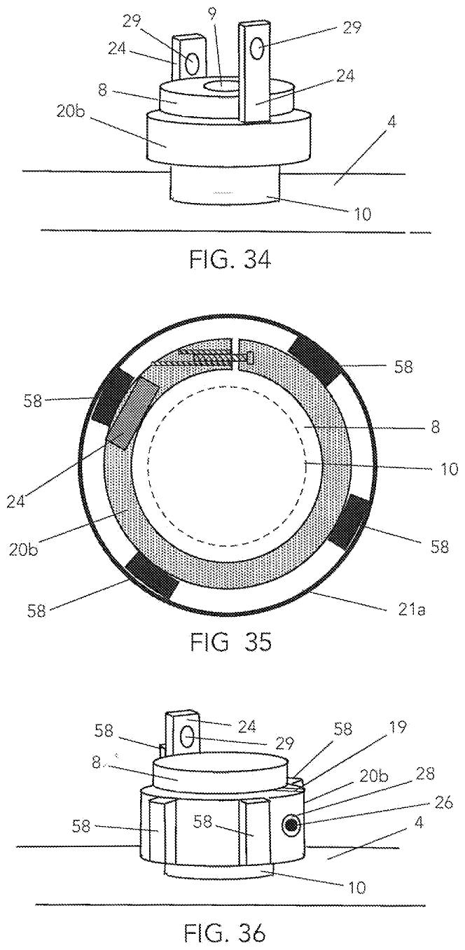

FIG. 32 is a side view of version-two of the invention showing the first collar attachment bars 24 in a differing length when compared to each other and the first collar second means for attachment holes 29 (see FIG. 34) positioned at a differing angle when compared to the angle of the tank fill port cap 8 top surface preventing the lockable blocking device 32a shackle 38 from blocking the opening of the tank fill port cap 8 centered pressure release device 9. The tank fill port cap 8 pressure release device 9 is generally spring controlled and pops out of the tank fill port cap 8 when pressure in the tank builds to a predetermined limit. The lock shackle toe is the portion of the shackle that protrudes through the two first collar second means for attachment holes 29. In the event the shackle heel 42 is cut apart or the shackle head 46 is cut apart and a curved portion of the shackle head 46 remains attached to the shackle toe 44, the shackle toe 44 will remain securely in the two first collar second means for attachment holes 29 maintaining the secure closed position of the tank fill port cap 8. The tank fill port nipple 10 shown attached to the tank 4.

FIG. 33 shows FIG. 32 with the second collar 21 installed being a version-two of the dual collar tank cap locking device 1. The second collar 21 is non-securely held in place by the stabilizing screws 30 while the second collar 21 is securely held in place by the first collar attachment bars 24 and the lockable blocking device 32a. The lockable blocking device 32a must be removed before the second collar 21 can be removed from the first collar 20b. The tank fill port nipple 10 attached to the tank 4. The padlock shackle toe 44 passing through the first collar attachment bars 24 holes 29 (see FIG. 34) and the second collar 21 (see FIG. 26).

FIG. 34 is a perspective view of version-two of the invention showing the first collar attachment bars 24 in a differing length when compared to each other and the first collar second means for attachment holes 29 positioned at a differing angle when compared to the angle of the tank fill port cap 8 top surface preventing the lockable blocking device 32a (see FIG. 33) shackle 38 (see FIG. 33) from blocking the opening of the tank fill port cap 8 centered pressure release device 9. The second collar is not shown installed.

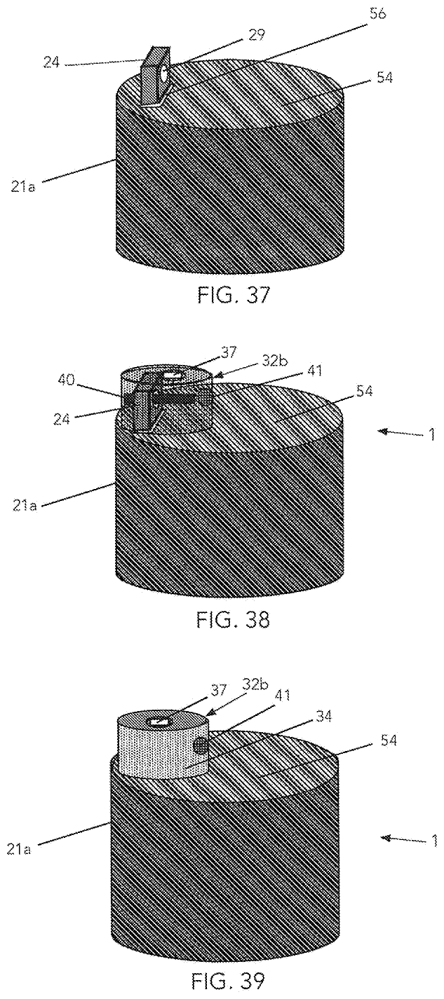

FIG. 35 is a top cutout view of version-one of the invention with only one first collar attachment bar 24, and showing spacers 58 attached to the first collar 20b to provide support for a larger hood diameter of the second collar with enclosing device hood and flat top 21a configuration. The larger hood diameter allows the first collar attachment bar 24 to be spaced away from the edge of the second collar hood top 54 (see FIG. 37) allowing for the use of hidden shackle style lockable blocking device 32b in a hockey puck shaped lock. The hidden shackle hockey puck style lock requires approximately ½ of an inch of additional attachment support away from the hidden shackle connection area of the shackle to the first collar attachment bar 24 hole 29 for the lock housing to be prevented from hanging over the edge of the second collar hood top 54 (see FIG. 38). The tank fill port cap 8 is shown with a cutout view of the tank fill port nipple 10 as a dotted line.

FIG. 36 is a perspective view of FIG. 35 showing the first collar spacers 58 on all four sides of the first collar 20b. The first collar is shown in a single split collar 20b while also showing the first collar slice 19, the first collar clamp screw 28 and the first collar head opening 28. The first collar attachment bar 24 and the first collar second means for attachment hole 29 is shown along with the tank fill port nipple 10 attached to the tank 4.

FIG. 37 shows FIG. 36 with the second collar with enclosing device hood and flat top 21a installed over the first collar 20b (not shown, see FIG. 36) with no lockable blocking device installed (see FIG. 38). The first collar attachment bar 24 is shown protruding through the first collar hood top 54 opening 56 allowing for a lockable blocking device (not shown, see FIG. 38) to be installed in the first collar 20b (see FIG. 36) second means of attachment hole 29.

FIG. 38 is a perspective view of FIG. 37 showing a transparent view of the lockable blocking device 32b hockey puck style lock installed in the first collar attachment bar hole 29 (see FIG. 37) providing the lockable blocking device 32b, thus, completing version-one of the dual collar tank cap locking device 1. The first collar attachment bar 24 is shown protruding through the top 54 of the second collar with enclosing device hood and flat top 21a, and is located inside the hockey puck lock with the hidden shackle 40 protruding through the second means of attachment hole 29 and exiting the other side of the hole 29. The lock keyway 37 is shown on the top of the lock 32b and the shackle set pin 41 is shown on the side of the lock 32b.

FIG. 39 is a perspective view of FIG. 38 showing the hockey puck lock 32b in a non-transparent view.

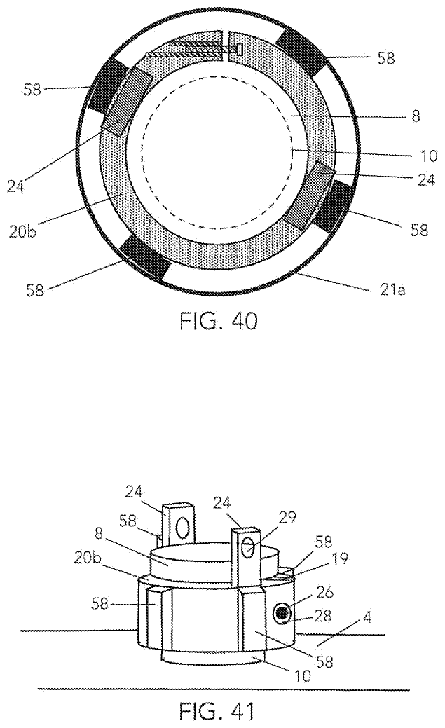

FIG. 40 is a top cutout view of version-two of the invention with two first collar attachment bars 24 showing first collar spacers 58 attached to the first collar 20b to provide support for a larger hood diameter of the second collar with enclosing device hood and flat top 21a configuration. FIG. 40 is the same drawing as FIG. 35 with the exception of one added first collar attachment bar 24. FIG. 35 is version-one of the disclosed invention and FIG. 40 is version-two of the disclosed invention.

FIG. 41 is a perspective view of FIG. 40 showing the first collar spacers. FIG. 41 is the same drawing as FIG. 36 with the exception of one added first collar attachment bar 24. FIG. 36 is version-one of the disclosed invention and FIG. 41 is version-two of the disclosed invention. Although the second collar 21a and lockable blocking device 32b are not installed on the first collar attachment bars 24.

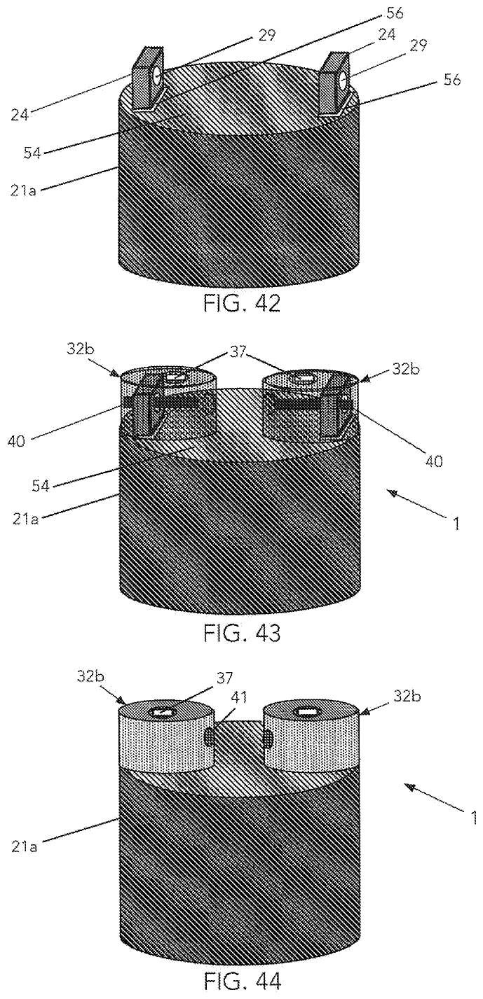

FIG. 42 is a perspective view of FIG. 41 showing the second collar with enclosing device hood and flat top 21a installed. FIG. 42 is the same drawing as FIG. 37 with the exception of one added first collar attachment bar 24. FIG. 37 is version-one of the disclosed invention and FIG. 42 is version-two of the disclosed invention. Although the lockable blocking device 32b is not installed on the first collar attachment bars 24.

FIG. 43 is a perspective view of FIG. 42 showing a transparent view of two hockey puck style locks installed in the first collar attachment bars 24 hole 29 Providing the lockable blocking devices 32b. FIG. 43 is the same drawing as FIG. 38 with the exception of one added first collar attachment bar 24 and one added lockable blocking device 32b. FIG. 38 is version-one of the disclosed invention and FIG. 43 is version-two of the disclosed invention, the dual collar tank cap locking device 1.

FIG. 44 is a perspective view of FIG. 43 showing the two hockey puck style locks in a non-transparent view, the locks installed in the first collar attachment bars 24 hole 29 Providing the lockable blocking devices 32b. FIG. 44 is the same drawing as FIG. 39 with the exception of one added first collar attachment bar 24 and one added lockable blocking device 32b. FIG. 39 is version-one of the disclosed invention and FIG. 44 is version-two of the disclosed invention, the dual collar tank cap locking device 1.

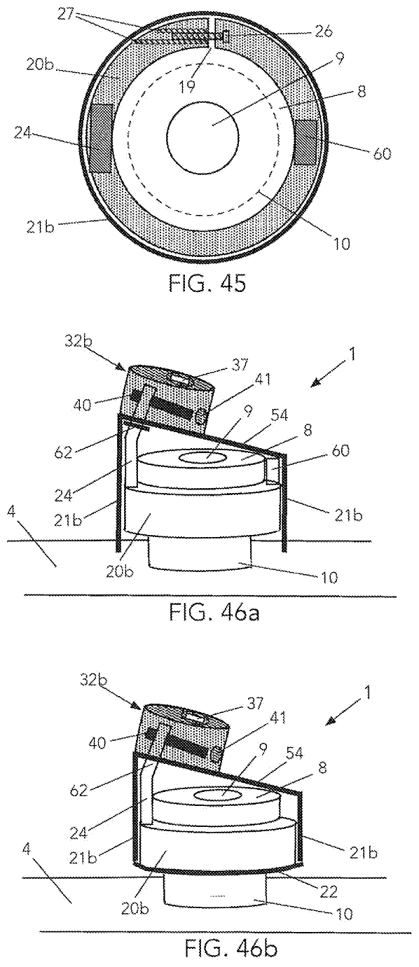

FIG. 45 is a top cutout view of version-one of the invention with only one first collar attachment bar 24 and showing no spacers 58 (see FIG. 40) attached to the first collar 20b, completing a version of the dual collar tank cap locking device 1. The drawing also shows a pressure relief device 9 installed in the center of the tank fill port cap 8. The tank fill port cap 8 is shown with a cutout view of the tank fill port nipple 10 as a dotted line. This version-one of the invention will comprise a second collar with enclosing device hood and sloped top 21b (see FIG. 46). The first collar clamp screw 26 is shown threaded inside the first collar clamp screw threads 27 with the first collar slice 19 shown, and a second collar support bar 60 is shown opposite the first collar attachment bar 24. The second collar support bar 60 provides support to the second collar with enclosing device hood and sloped top 21b to keep the second collar with enclosing device hood and sloped top 21b from resting on the tank fill port cap 8 (see FIG. 46).

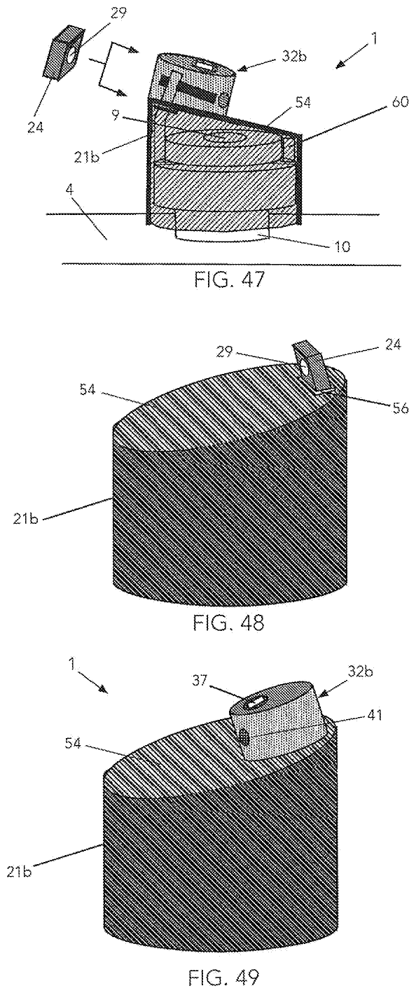

FIG. 46a is a side view of the dual collar tank cap locking device 1 version-one with the second collar with enclosing device hood and sloped top 21b outlined with a sloped top installed over the first collar 20b, and a hockey puck style lock installed as a lockable blocking device 32b. The shackle 40 of the hockey puck style lock is protrudes through the first collar attachment bar hole 29 (see FIG. 47), the lock keyway 37 and the lock shackle set pin 41 is shown along with a second collar support plate 62 is provided to support the height of the second collar with enclosing device hood and sloped top 21b at the higher sloped end of the second collar 21b. The second collar support bar 60 is shown supporting the second collar with enclosing device hood and sloped top 21b lower end of the sloped hood top. The first collar attachment bar 24 is shown in a bent style to accommodate the sloped hood, and in addition, the bent style of the collar attachment bar 24 removes the need for the first collar spacers 58 as the positioning of the bent first collar attachment bar 24 moves the position of the first collar attachment bar 24 protrusion through the second collar hood top 54 through the second collar hood top opening 56 (see FIG. 48). The drawing also shows a pressure relief device 9 installed in the center of the tank fill port cap 8, and also shown is the tank fill port nipple 10 attached to the tank 4. The second collar support bar 60 provides support to the second collar with enclosing device hood and sloped top 21b to keep the second collar 21b from resting on the tank fill port cap 8.

FIG. 46b is a similar drawing of FIG. 46a. FIG. 46a comprises a second collar support bar 60 and a second collar support plate 62 to support the second collar with enclosing device hood and sloped top 21b, while FIG. 46b comprises a second collar base rim 22 to support the second collar 21b.

FIG. 47 is a similar side view of FIG. 46 version-one showing the hood in a transparent view with a sloped top installed over the first collar with enclosing device hood and sloped top 21b with a hockey puck style lock installed as a lockable blocking device 32b. FIG. 47 also shows the position of the first collar attachment bar 24 and its attachment hole 29 being visible.

FIG. 48 is a perspective non-transparent view of FIG. 47 version-one without the lockable blocking device installed 32b (see FIG. 47) and showing the second collar with enclosing device hood and sloped top 21b installed. The bent first collar attachment bar 24 and first collar second means for attachment hole 29 is shown protruding through the second collar hood top 54 at the second collar hood top opening 56.

FIG. 49 is a perspective non-transparent view of FIG. 48 version-one with the hockey puck lock installed as the lockable blocking device 32b completing the dual collar tank cap locking device 1.

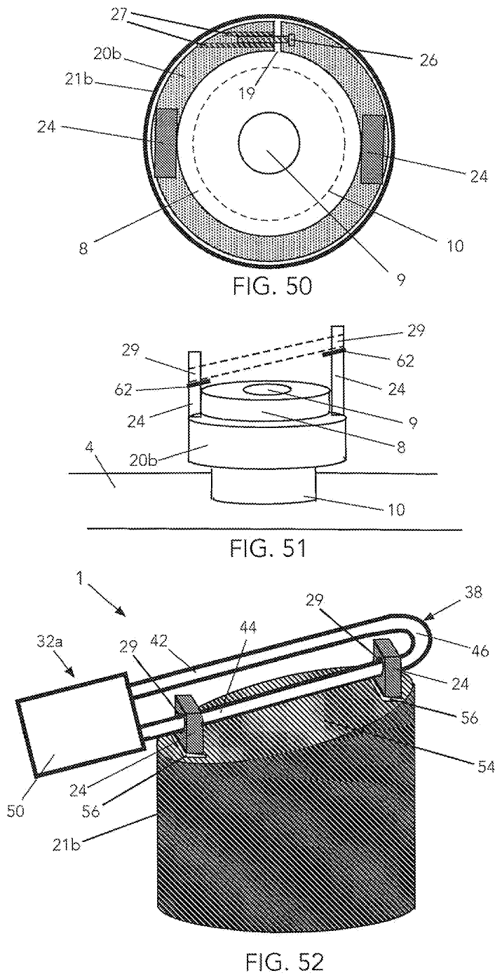

FIG. 50 is a top cutout view of version-two of the invention similar to version-one of the invention in FIG. 45 with the exception that FIG. 50 has two first collar attachment bars 24 instead of only one. The drawing shows no first collar spacers 58 attached to the first collar 20b. The drawing also shows a pressure relief device 9 installed in the center of the tank fill port cap 8, and the first collar slice 19 where the first collar clamp screw 26 and the first collar clamp screws threads 27 are positioned. The second collar with enclosing device hood and sloped top 21b is shown positioned around the first collar 20b, and the tank fill port nipple 10 is shown as a dotted line.

FIG. 51 is a perspective view of version-two of the invention without a second collar with enclosing device hood and sloped top 21b (see FIG. 52) or a lockable blocking device 32a (see FIG. 52) installed, and showing the first collar 20b and the first collar attachment bars 24 in differing lengths when compared to each other, and the first collar second means for attachment 29 positioned at a degrees angle difference 23d when compared to the angle of the tank fill port cap 8 top surface with a second collar support plate 62 attached to each first collar attachment bar 24 preventing the second collar hood top 54 (see FIG. 52) from blocking the opening of the cap centered tank fill port cap pressure release 9. The tank fill port nipple 10 shown attached to the tank 4.

FIG. 52 is a perspective view of FIG. 51 showing the second collar with enclosing device hood and sloped top 21b installed under the lockable blocking device padlock 32a and supported by the two second collar support plates 62 completing the dual collar tank cap locking device 1. The first collar attachment bars 24 and first collar second means for attachment holes 29 are shown protruding through the second collar hood top 54 at the second collar hood top openings 56. The padlock shackle 38 shackle toe 44 protrudes through each first collar second means for attachment hole 29 while the shackle heel 42 and the shackle head 46 remain outside of the first collar second means for attachment holes 29. The padlock body 50 is also shown. The second collar with enclosing device hood and sloped top 21b hood top 54 is supported by the two second collar support plates 62 (see FIG. 51).

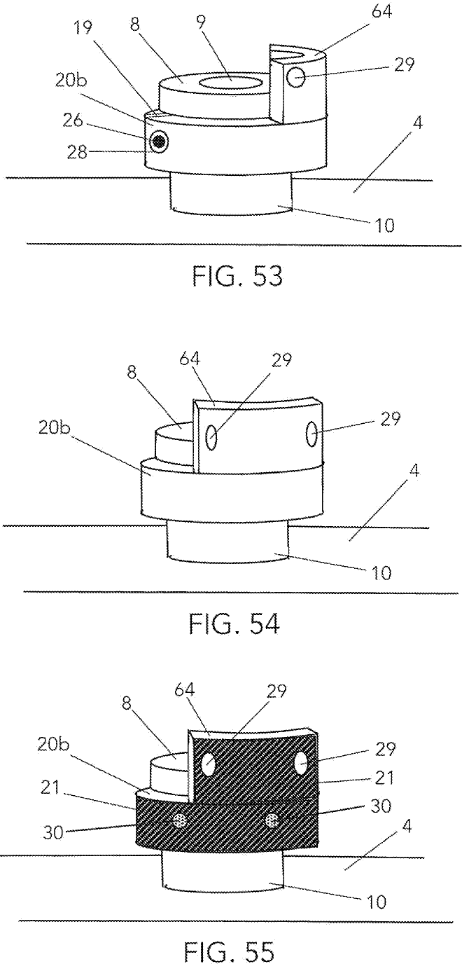

FIG. 53 is a perspective view of the version-three of the invention showing the first collar 20b without the second collar 21 installed (see FIG. 55), and showing the first collar curved attachment bar 64 comprising two attachment holes 29 (see FIG. 54 for both holes). Also showing the single split first collar clamp screw 26, first collar slice 19, and the clamp screw head opening 28. The tank fill port nipple 10 shown attached to the tank 4. The tank fill port cap 8 and the pressure relief device 9 centered on the cap are also shown.

FIG. 54 is another slightly rotational turned view of FIG. 53 showing version-three of the invention and both first collar attachment bar holes 29 in the first collar curved attachment bar 64, The first collar curved attachment bar 64 being attached to the first collar 20b. In addition, showing the tank fill port cap 8 and the tank fill port nipple 10 attached to the tank 4.

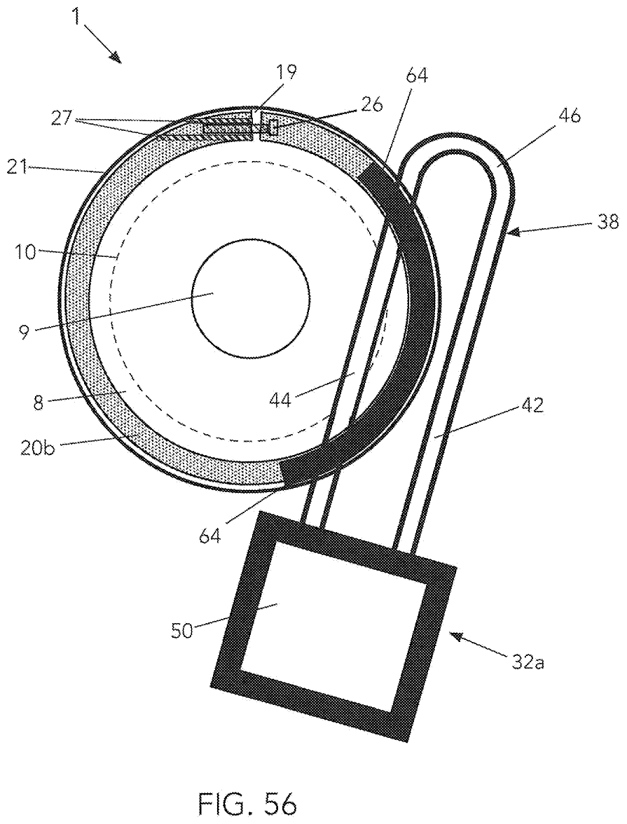

FIG. 55 shows FIG. 54 version-three of the invention with the second collar 21 installed and no lockable blocking device 32a (see FIG. 56) installed. The stabilizing screws 30 are also shown installed stabilizing the second collar 21 attachment to the first collar 20b and keeping the second collar in place when there is no lockable blocking device 32a (see FIG. 56) installed on the first collar second means of attachment 29.

FIG. 56 is a top cutout view of the version-three of the invention with both the first collar 20b and the second collar 21 installed, and in addition, showing a padlock installed as the lockable blocking device 32a completing the dual collar tank cap locking device 1. The first collar 20b is shown as a single split collar 20b to be compressed around the fill port nipple 10 (shown as a dotted line and hidden by the tank fill port cap 8). The compression of the first collar 20b is achieved using the first collar clamp screw 28 tightened into the first collar clamp screw threads 27 to compress the first collar slice 19. The first collar curved attachment bar 64 is shown with the lockable blocking device 32a being a padlock with the shackle 38 being used as the lockable blocking device 32a. The shackle toe 44 passes through both first collar attachment bar holes 29 (see FIG. 55) while the shackle heel 46 and the shackle head 46 are on the outside of the first collar curved attachment bar 64. The shackle toe 44 is shown being over top of the tank fill port cap 8 edge, preventing the tank fill port cap 8 from being removed from the tank fill port nipple 10. The pressure relief device 9 in unobstructed by the lockable blocking device 32a allowing the pressure relief device 9 to release pressure from the tank 4 (not shown) is required.

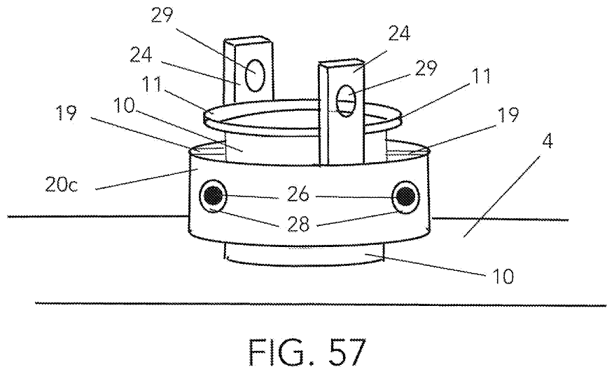

FIG. 57 is a perspective view of version-two of the invention without the second collar (see FIG. 16) installed, showing the two first collar attachment bars 24. Also showing the fill port nipple flange 11. The first collar is a single split collar 20c that can be split apart and attached around the tank fill port nipple 10 clearing the tank fill port nipple flange 11 without needing to be slid over the top of the tank fill port nipple 10. The tank fill port nipple 10 normally has female threads inside the tank fill port nipple 10 to accept a tank fill port cap 8 with male threads. The first collar attachment bars 24 are attached to the first collar 20c along side of the tank fill port nipple flange 11.

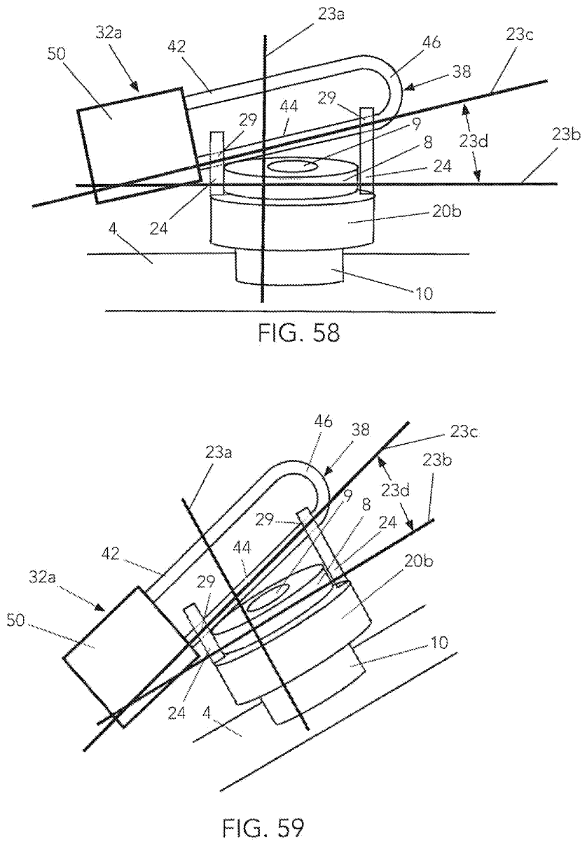

FIG. 58 is a perspective view of version-two of the invention without the second collar installed. This drawing is the same drawing as FIG. 32 with the first plane 23a, the second plane 23b and the degrees angle difference 23d between the second plane 23b and the third plane 23c being added to the drawing. The second plane 23b represents a plane parallel to the top surface of the fill port cap 8 and the first plane 23a represents a plane perpendicular to the second plane 23b. The fill port cap 8 resides in the first plane 23a. The fill port nipple 10 is attached on a horizontal section of the tank 4. The third plane 23c represents a plane parallel with the lock shackle 46 showing the different angle of the length of the lock shackle 38 when compared to the angle of the tank fill port cap 8 top surface. The different angle between the second plane 23b and the third plane 23c requires the distance of separation of the lock shackle 38 to the outer edge of the top surface of the fill port cap 8 to be substantially less than the distance of separation of the lock shackle 38 to the center of the fill port cap 8. This different length of separation allows the fill port 8 pressure relief device 9 to work properly by keeping the shackle 38 from interfering with the operation of the fill port cap 8 pressure relief device 9.

FIG. 58 in addition shows the lockable blocking device 32a, the padlock body 50, the shackle heel 42, the shackle head 46, and the shackle toe 44. The tank 4 is shown in a horizontal orientation with the fill port nipple 10 attach to the tank 4. The shackle toe 44 is show protruding through each first collar attachment bar 24 through the first collar second means of attachment hole 29. The fill port cap 8 is show with a fill port cap pressure relief device 9 in the center of the cap. The fill port pressure relief device 9 normally will pop up to release pressure from the tank 4 when needed. The first collar 20b is shown and the second collar 21 (see FIG. 33) is not shown.

FIG. 59 is the same drawing of FIG. 58 with the fill port nipple 10 attached on a thirty-degree angled section of the tank 4. In FIG. 59, the angle relationship between the first plane 23a and the second plane 23b is the same angle relationship as the FIG. 58 angle relationship between the first plane 23a and the second plane 23b. In FIG. 59, the first plane 23a is also perpendicular to the second plane 23b even though, the second plane 23b is no longer horizontal. The second plane 23b is still parallel to the top surface of the fill port cap 8. The degrees angle difference 23d between the second plane 23b and the third plane 23c remains the same as in FIG. 58.

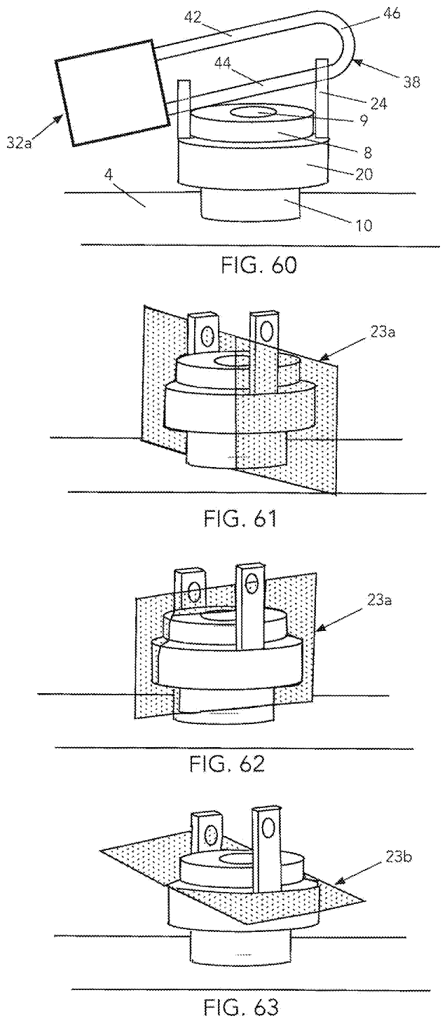

FIG. 60 is a frontal view of version-two of the disclosed invention 1 without the second collar 21 (see FIG. 33) installed and showing the lockable blocking device padlock 32a. FIG. 60 is the same drawing as FIG. 32 (see FIG. 32) showing the shackle toe 44 making contact with the fill port cap 8 outer edge of the top surface of the fill port cap 8. The distance of separation from the shackle toe 44 to the outer edge of the top surface of the fill port cap 8 is substantially less than the distance of separation from the shackle toe 44 to the center of the fill port cap 8, therefore, the shackle toe 44 is not able to obstruct the operation of the fill port cap 8 pressure relief device 9 centered in the top of the fill port cap 8.

FIG. 61 is a perspective view of version-two of the disclosed invention 1 showing the frontal view of FIG. 60 without the lockable blocking device padlock 32a, the invention is turned at an approximately forty-five degree angle, while also showing the first plane 23a that is perpendicular from the second plane 23b (see FIG. 63). The first plane 23a in this drawing is a frontal plane (side to side). The second plane 23b (see FIG. 63) is a transverse plane.

FIG. 62 is a perspective view of version-two of the disclosed invention 1 showing the frontal view of FIG. 60 without the lockable blocking device padlock 32a, the invention is turned at an approximately forty-five degree angle, while also showing the first plane 23a that is perpendicular from the second plane 23b (see FIG. 63). The first plane 23a in this drawing is a saggital plane (front to back). Both the frontal plane 23a in FIG. 61 and the saggital plane in FIG. 62 are perpendicular planes when compared to the second plane 23b (see FIG. 63).

FIG. 63 is a perspective view of version-two of the disclosed invention 1 showing the frontal view of FIG. 60 without the lockable blocking device padlock 32a, the invention is turned at an approximately forty-five degree angle, while also showing the second plane 23b that is parallel with the top surface of the fill port cap 8. When the orientation of the tank 4 is horizontal and the fill port nipple 10 orientation is vertical, the second plane 23b is a horizontal transverse plane.

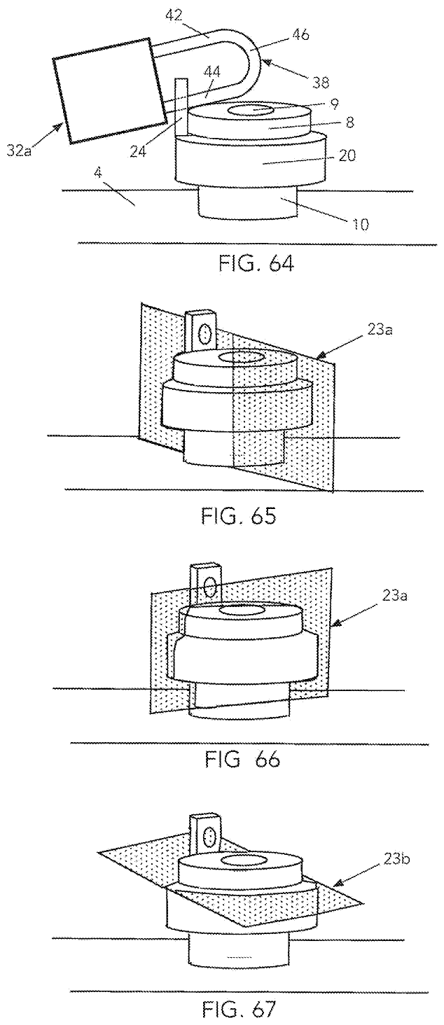

FIG. 64 is a frontal view of version-one of the disclosed invention 1 without the second collar 21 (see FIG. 11) installed and showing the padlock installed as the lockable blocking device 32a. The second collar is not shown. FIG. 64 is a similar drawing as FIG. 10 (see FIG. 10) showing the shackle toe 44 making contact with the fill port cap 8 outer edge of the top surface of the fill port cap 8. The distance of separation from the shackle toe 44 to the outer edge of the top surface of the fill port cap 8 is substantially less than the distance of separation from the shackle toe 44 to the center of the fill port cap 8, therefore, the shackle toe 44 is not able to obstruct the operation of the fill port cap 8 pressure relief device 9 centered in the top of the fill port cap 8.

FIG. 65 is a perspective view of version-one of the disclosed invention 1 showing the frontal view of FIG. 64 without the lockable blocking device padlock 32a, the invention is turned at an approximately forty-five degree angle, while also showing the first plane 23a that is perpendicular from the second plane 23b (see FIG. 67). The first plane 23a in this drawing is a frontal plane (side to side). The second plane 23b (see FIG. 67) is a transverse plane.

FIG. 66 is a perspective view of version-one of the disclosed invention 1 showing the frontal view of FIG. 64 without the lockable blocking device padlock 32a, the invention is turned at an approximately forty-five degree angle, while also showing the first plane 23a that is perpendicular from the second plane 23b (see FIG. 67). The first plane 23a in this drawing is a saggital plane (front to back). Both the frontal plane 23a in FIG. 65 and the saggital plane in FIG. 66 are perpendicular planes when compared to the second plane 23b (see FIG. 67).

FIG. 67 is a perspective view of version-one of the disclosed invention 1 showing the frontal view of FIG. 64 without the lockable blocking device padlock 32a, the invention is turned at an approximately forty-five degree angle, while also showing the second plane 23b that is parallel with the top surface of the fill port cap 8. When the orientation of the tank 4 is horizontal and the fill port nipple 10 orientation is vertical, the second plane 23b is a horizontal transverse plane.

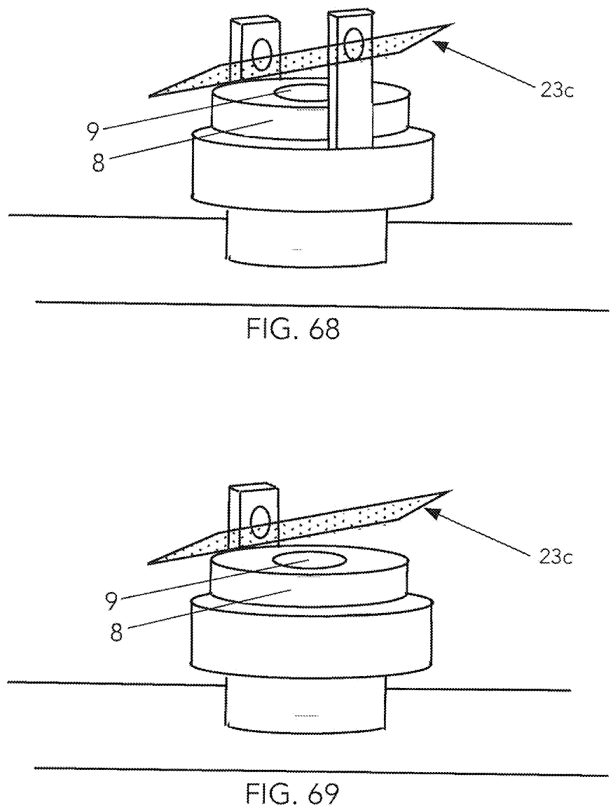

FIG. 68 is a perspective view of version-two of the disclosed invention 1 showing the frontal view of FIG. 60 without the lockable blocking device padlock 32a (see FIG. 60), the invention is turned at an approximately forty-five degree angle, while also showing the third plane 23c the lock shackle 38 would be positioned in (see FIG. 60). The distance of separation from the third plane 23c to the outer edge of the top surface of the fill port cap 8 is substantially less than the distance of separation from the third plane 23c to the center of the fill port cap 8 pressure relief device 9.

FIG. 69 is a perspective view of version-two of the disclosed invention 1 showing the frontal view of FIG. 64 without the lockable blocking device padlock 32a (see FIG. 64), the invention is turned at an approximately forty-five degree angle, while also showing the third plane 23c the lock shackle 38 would be positioned in (see FIG. 64). The distance of separation from the third plane 23c to the outer edge of the top surface of the fill port cap 8 is substantially less than the distance of separation from the third plane 23c to the center of the fill port cap 8 pressure relief device 9.

The dual collar tank cap blocking device 1 provides a means for the attachment of a lockable blocking device 32 with a lock shackle 38 to block a tank fill-port cap 8 from being removed from a tank fill-port nipple 10, the dual collar tank cap blocking device 1 comprises:
a) a first collar 20 to partially or fully surround the circumference of the tank fill-port nipple 10;
b) the first collar 20 comprising a first means for attachment 25, 26 to removably attach the first collar 20 to the tank fill-port nipple 10, the first collar 20 first means for attachment 25, 26 to the tank 4 fill port nipple 10 being adjustable screws such as setscrews 25 or clamp screws 26 applying pressure from the first collar 20 to the wall of the tank fill port nipple 10 resulting in a tight, rigid, and non-movable condition of the first collar 20 around the tank fill port nipple 10;
c) the first collar 20 comprising a second means for attachment 29 such as a hole 29 enabling a secure and removable attachment of the first collar 20 to the lockable blocking device 32 lock shackle 38, the first collar 20 second means for attachment 29 position and configuration requires the lockable blocking device 32 shackle 38 to be;
   I. positioned in a first plane 23a, the first plane 23a being perpendicular to a second plane 23b, the second plane 23b being a transverse plane that is parallel with the top surface of the fill port cap 8, the fill port cap 8 resides in the first plane 23a, the portion of the lockable blocking device 32 shackle 38 protruding through the first collar 20 second means for attachment 29 being higher in altitude than the lowest portion of the fill port cap 8 top surface; and
   II. positioned wherein the lockable blocking device 32 cannot interfere with or block the opening of a pressure relief device 9 that may be centered in the top surface of the fill port cap 8 even in the event the lockable blocking device 32 is making contact with the fill port cap 8 top surface, the position of the lockable blocking device 32 shackle 38 being;
      i. in a third plane 23c and orientated lengthwise aligned and non-parallel aligned when compared to the second plane 23b, the third plane 23c being positioned at a degrees angle difference 23d than the angle of the top surface of the fill port cap 8, the third plane 23c angle of the shackle 38 requiring the distance of separation from the shackle 38 to the outer edge of the top surface of the fill port cap 8 to be substantially less than the distance of separation from the shackle 38 to the center of the fill port cap 8; or
      ii. no more than twenty percent of the fill port cap 8 diameter away from the fill port cap 8 outer edge; or
      iii. in a third plane 23c and orientated lengthwise aligned and non-parallel aligned when compared to the second plane 23b, the third plane 23c being positioned at a degrees angle difference 23d than the angle of the top surface of the fill port cap 8, the third plane 23c angle of the shackle 38 requiring the distance of separation from the shackle 38 to the outer edge of the top surface of the fill port cap 8 to be substantially less than the distance of separation from the shackle 38 to the center of the fill port cap 8, and no more than twenty percent of the fill port cap 8 diameter away from the fill port cap 8 outer edge;
   d) a second collar 21 that partially covers or fully covers a portion of, or all of the circumference of the first collar 20, the second collar 21 length extending in the direction of the first collar 20 length, the second collar 21 covers and blocks the removal of the first collar 20 first means for attachment 25, 26 to the tank fill-port nipple 10, and the second collar 21 being secured in position by attachment to the lockable blocking device 32a lock shackle 38; and

with the first collar 20 first means for attachment 25, 26 attached to the tank fill-port nipple 10, the second collar 21 mounted around the first collar 20, the first collar 20 second means for attachment 29 and the second collar 21 attached to the lockable blocking device 32 lock, and the lockable blocking device 32 in the locked position;
i) the second collar 21 maintains a confined position covering and preventing the removal of the first collar 20 first means for attachment 25, 26 to the tank fill-port nipple 10, therefore, securely maintaining the position of the first collar 20 on the tank 4 fill-port nipple 10; and
ii) the tank fill-port cap 8 is blocked from removal from the fill port of the fill port nipple 10 and the fill port cap 8 pressure relief device 9 if provided, performs properly.

The dual collar tank cap locking device 1 may be marketed and sold with or without the lockable blocking device 32 such as a padlock. In the event the disclosed invention 1 is sold without the lockable blocking device 32, the end user can simply supply their own padlock or other device to be used as a lockable blocking device 32.

The dual collar tank cap locking device 1 can comprise either one of a), b), or c):
a) the lockable blocking device 21 blocks the removal of the tank fill-port cap 8 by restricting the opening motion of the tank fill-port cap 8; or
b) the second collar 21 comprises an enclosing device 21a, 21b enclosing the space around the tank 4 fill-port tank cap 8, therefore, blocking access to the tank fill-port cap 8, and the lockable blocking device 32 blocks the removal of the second collar with enclosing device 21a, 21b, therefore, blocking the removal of the tank fill-port cap 8; or
c) i) the lockable blocking device 32 blocks the removal of the tank fill-port cap 8 by restricting the opening motion of the tank fill-port cap 8; and
   ii) the second collar 21 comprises an enclosing device 21a, 21b enclosing the space around the tank 4 fill-port tank cap 8, therefore, blocking access to the tank fill-port cap 8, and the lockable blocking device 32 blocks the removal of the second collar with enclosing device 21a, 21b, therefore, blocking the removal of the tank fill-port cap 8.

The dual collar tank cap locking device 1 can be configured wherein the first collar 20 second means for attachment 29 requires the blocking device 32 is positioned at a degrees angle difference 23d when compared to the angle of the tank fill port cap 8 top surface preventing the lockable blocking device 32 from blocking the opening of the tank fill port cap 8 centered pressure release device 9. The angle of the lockable blocking device 32 will clear the pressure relief device 9 and allow the pressure relief device 9 to open when needed. The degrees angle difference 23d can be fifteen degrees of angle, or in the range of ten to twenty five degrees of angle, or any other angle of degrees to allow the lockable blocking device 32 to block the centered fill port cap 8 from opening, but still allow the pressure relief device 9 to open and release pressure from the tank 4.

The dual collar tank cap locking device 1 first collar 20 can be a split-clamping collar 20b, 20c, 20d and wherein the first collar 20 first means for attachment 25, 26 can be one or more clamp screws 26. The first collar 20 split-clamping collar can be a single-split-clamping collar 20b, double-split-clamping collar 20c, or triple-split-clamping collar 20d. The first collar 20 can be a continuous circumference collar 20a with the first collar 20 first means for attachment 25, 26 being one or more setscrews 25.

The dual collar tank cap locking device 1 setscrew 25 heads can be a countersunk design head and the setscrews 25 can be countersunk in the first collar 20 when the setscrews 25 are in the tightened and secured position, the setscrews 25 can be held in the tightened and secured position by a substantial amount of torque with the greatest amount of torque transferred to the setscrew heads pressed against the first collar 20 while also employing a limited but sufficient amount of force transferred to the setscrew 25 tips against the tank fill-port nipple 10 to maintain the position of the first collar 20 on the tank fill-port nipple 10 without undo damage to the tank fill port nipple 10.

The second collar 21 can comprise a stabilizing means such as stabilizing screws 30 for attaching the second collar 21 to the first collar 20 providing a stabilized position of the second collar 21 when the first collar 20 second means of attachment 29 such as a padlock is not installed. This would be an advantage when the second collar 21 is not a hooded collar wherein the blocking device 32 that protrudes through the first collar 20 second means of attachment hole 29 or holes 29.

The first collar attachment bar 24 or bars 24 will normally comprise one hole 29 on each bar for the first collar second means of attachment 29 for a padlock shackle 38 or other device. The dual collar tank cap locking device 1 comprising at least one hole for the first collar second means of attachment 29. The first collar 20 can comprise either one hole or two holes for the second means of attachment 29. The first collar 20 and the second collar 21 are normally made out of a very durable composition such as a metal like carbon steel, aluminum, or stainless steel. Other metal compositions and even non-metal compositions may also be appropriate such as a carbon fiber material.

The first collar 20 attachment position to the fill port nipple 10 normally is available with room for adjustability along the tank fill port nipple 10 to accommodate the desired space between the lockable blocking device 32 and the tank fill port cap 8. The lockable blocking device 32 or the second collar with enclosing device hood and flat top 21a, or sloped top 21b generally would be placed close to the tank fill port cap 8 without touching the tank fill port cap 8. If the lockable blocking device 32 is not of the hooded style 21a, 21b that prevents access to the tank fill port cap 8, the lockable blocking device 32 is required to be close enough to the tank fill port cap 8 to prevent the tank fill port cap 8 from being removed from the tank fill port nipple 10 whether the tank fill port cap 8 is a threaded cap or a hinged cap, or any other style of tank fill port cap 8.

In the case the tank fill port cap 8 comprises a pressure relief device 9, the most appropriate version of the invention to use is wherein the lockable blocking device 32 is directed at an angle that is great enough of an angle to require the lockable attachment device 32a will allow the tank fill port cap 8 pressure relief device 9 to open and relief pressure from the tank 4 (see FIG. 32). The version of the disclosed invention wherein the lockable blocking device 32 is not situated at an angle that is different than the angle of the tank fill port cap 8 top can still be used if the tank fill port cap 8 comprises a pressure relief device 9, but care must be taken to position the lockable blocking device 32 or the hood top 54 is used with enough clearance from the pressure relief device 9 to allow the pressure relief device 9 to open when needed (see FIG. 14). Although FIG. 14 does not show a pressure relief device 9, the clearance between the hood top 54 and the fill port cap 8 is viewable.

The injection of a liquid or other product with viscosity into a tank such as a fuel or water tank usually requires the product to flow into the tank using gravity, therefore, most tank fill port nipples are positioned in a plane angled above the horizontal plane to allow a gravity assisted flow of product into the tanks through the fill port of the tank. The horizontal plane being a plane perpendicular to the gradient of the gravity field at that particular point, in other words, apparent gravity makes a plumb-bob device hang perpendicular to the horizontal plane. With the disclosed invention attached to a fill port nipple that is parallel with the vertical plane or at any angle above the horizontal plane, the portion of the lock shackle that protrudes through the first collar second means of attachment will always be higher in altitude than the lowest point of the fill port cap top surface. Altitude being defined as “the vertical elevation of an object above a surface.”

This related position relationship as above stated of the lock shackle always being higher in altitude than the lowest point of the fill port cap top surface will always remain the same at any angle the fill port nipple and cap reside in other than in or below the horizontal plane.

The foregoing detailed description is given primarily for clearness of understanding and no unnecessary limitations are to be understood therefrom, for modification will become obvious to those skilled in the art upon reading this disclosure and may be made without departing from the spirit of the invention and scope of the appended claims.

I claim:

1. A dual collar tank cap blocking device providing a means for the attachment of a lockable blocking device to block a tank fill-port cap from being removed from a tank fill-port nipple, the dual collar tank cap blocking device comprises:
a) a first collar to partially or fully surround the circumference of the tank fill-port nipple;
b) the first collar comprising a first means for attachment to attach the first collar to the tank fill-port nipple, resulting in a tight, rigid, and non-movable condition of the first collar around the tank fill port nipple;
c) the first collar comprising a second means for attachment enabling a secure and removable attachment of the first collar to a lockable blocking device shackle, the first collar second means for attachment position and configuration requires the lockable blocking device shackle to be;
I) positioned in a first plane, the first plane being perpendicular to a second plane, the second plane being a transverse plane that is parallel with the top surface of the fill port cap, the fill port cap resides in the first plane, the portion of the lockable blocking device shackle protruding through the first collar second means for attachment being higher in altitude than the lowest portion of the fill port cap top surface; and
II) positioned wherein the lockable blocking device cannot interfere with or block the opening of a pressure relief device that may be centered in the top surface of the fill port cap even in the event the lockable blocking device is making contact with the fill port cap top surface, the position of the lockable blocking device shackle being;
i) in a third plane and orientated lengthwise aligned and non-parallel aligned when compared to the second plane, the third plane being positioned at a degrees angle difference than the angle of the top surface of the fill port cap, the third plane angle of the shackle requiring the distance of separation from the shackle to the outer edge of the top surface of the fill port cap to be substantially less than the distance of separation from the shackle to the center of the fill port cap; or
ii) no more than twenty percent of the fill port cap diameter away from the fill port cap outer edge; or
iii) in a third plane and orientated lengthwise aligned and non-parallel aligned when compared to the second plane, the third plane being positioned at a degrees angle difference than the angle of the top surface of the fill port cap, the third plane angle of the shackle requiring the distance of separation from the shackle to the outer edge of the top surface of the fill port cap to be substantially less than the distance of separation from the shackle to the center of the fill port cap, and no more than twenty percent of the fill port cap diameter away from the fill port cap outer edge;
d) a second collar that partially covers or fully covers a portion of, or all of the circumference of the first collar, the second collar length extending in the direction of the first collar length, the second collar covers and blocks the removal of the first collar first means for attachment to the tank fill-port nipple, and the second collar being secured in position by attachment to the lockable blocking device; and
with the first collar first means for attachment attached to the tank fill-port nipple, the second collar mounted around the first collar, the first collar second means for attachment and the second collar attached to the lockable blocking device, and the lockable blocking device in the locked position;
i) the second collar maintains a confined position covering and preventing the removal of the first collar first means for attachment to the tank fill-port nipple, therefore, securely maintaining the position of the first collar on the tank fill-port nipple; and
ii) the tank fill-port cap is blocked from removal from the fill port of the fill port nipple, and the fill port cap pressure relief device if provided, is not obstructed from operation.

2. The dual collar tank cap locking device of claim 1 comprising the lockable blocking device.

3. The dual collar tank cap locking device of claim 2 comprising either one of a), b), or c):
a) the lockable blocking device blocks the removal of the tank fill-port cap by restricting the opening motion of the tank fill-port cap; or
b) the second collar comprises an enclosing device enclosing the space around the tank fill-port tank cap, therefore, blocking access to the tank fill-port cap, and the lockable blocking device blocks the removal of the enclosing device, therefore, blocking the removal of the tank fill-port cap; or
c) i) the lockable blocking device blocks the removal of the tank fill-port cap by restricting the opening motion of the tank fill-port cap; and
ii) the second collar comprises an enclosing device enclosing the space around the tank fill-port tank cap blocking access to the tank fill-port cap, and the lockable blocking device blocks the removal of the enclosing device, therefore, blocking the removal of the tank fill-port cap.

4. The dual collar tank cap locking device of claim 1 wherein the degrees angle difference is in the range of ten to twenty five degrees.

5. The dual collar tank cap locking device of claim 1 wherein the first collar is a split-clamping collar and the first collar first means for attachment is one or more clamp screws.

6. The dual collar tank cap locking device of claim 5 wherein the split-clamping collar is a single-split-clamping collar.

7. The dual collar tank cap locking device of claim 5 wherein the split-clamping collar is a double-split-clamping collar.

8. The dual collar tank cap locking device of claim 5 wherein the split-clamping collar is a triple-split-clamping collar.

9. The dual collar tank cap locking device of claim 1 wherein the first collar is a continuous circumference collar and the first means for attachment is one or more setscrews.

10. The dual collar tank cap locking device of claim 9 wherein the setscrew heads are a countersunk design head and the setscrews are countersunk in the first collar when the setscrews are in the tightened and secured position, the setscrews are held in the tightened and secured position by a substantial amount of torque with the greatest amount of torque transferred to the setscrew heads pressed against the first collar while also employing a limited but sufficient amount of force transferred to the setscrew tips against the tank fill-port nipple to maintain the position of the first collar on the tank fill-port nipple.

11. The dual collar tank cap locking device of claim 1 wherein the second collar comprises a stabilizing means for attaching the second collar to the first collar providing a stabilized position of the second collar.

12. The dual collar tank cap locking device of claim 2 wherein the lockable blocking device comprises a lock shackle.

13. The dual collar tank cap locking device of claim 12 wherein the shackle is a hidden shackle.

14. The dual collar tank cap locking device of claim 13 wherein the hidden shackle lockable blocking device is a hockey puck style lock.

15. The dual collar tank cap locking device of claim 12 wherein the lockable blocking device is a padlock.

16. The dual collar tank cap locking device of claim 12 wherein the lockable blocking device is a pin and barrel lock.

17. The dual collar tank cap locking device of claim 1 comprising at least one hole for the first collar second means for attachment to the lockable blocking device.

18. The dual collar tank cap locking device of claim 1 comprising two holes for the first collar second means for attachment to the lockable blocking device.

19. The dual collar tank cap locking device of claim 1 wherein the first collar and the second collar composition is a metal.

20. The dual collar tank cap locking device of claim 1 wherein the first collar is adjustable along the fill-port nipple length.

21. A system comprising:
a) a tank comprising a fill-port nipple and a fill-port cap; and
b) the dual collar tank cap locking device of claim 1.

22. A system comprising:
a) a tank comprising a fill-port nipple and a fill-port cap; and
b) the dual collar tank cap locking device of claim 2.

23. The dual collar tank cap locking device of claim 1 wherein the first collar first means for attachment to the tank fill port nipple is an adjustable screw or screws applying pressure from:
i) the first collar that presses against the circumference of the fill port nipple; or
ii) the adjustable screw or screws against the wall of the tank fill port nipple; or
iii) the first collar that presses against the circumference of the fill port nipple, and the adjustable screw or screws against the wall of the tank fill port nipple.

24. The dual collar tank cap locking device of claim 1 wherein the first collar first means for attachment to the tank fill port nipple is a removable attachment.
